(19) United States
(12) Patent Application Publication
(10) Pub. No.: US 2006/0144530 A1
(43) Pub. Date: Jul. 6, 2006

(54) Sheet shutter

(76) Inventors: Toyohide Nagare, Tokyo (JP); Hideki Tanemura, Tokyo (JP); Atsushi Matsumura, Tokyo (JP); Masahito Goto, Tokyo (JP); Takashi Nagata, Tokyo (JP); Katsuhiro Sakamoto, Tokyo (JP)

Correspondence Address: OLIFF & BERRIDGE, PLC, P.O. BOX 19928, ALEXANDRIA, VA, 22320, US

(21) Appl. No.: 10/528,574

(22) PCT Filed: Jun. 30, 2004
(86) PCT No.: PCT/JP04/09579

§ 371 Date: Mar. 21, 2005

(30) Foreign Application Priority Data
Aug. 12, 2003 (JP) 2003-292344
Aug. 12, 2003 (JP) 2003-292343

(51) Int. Cl. E06B 9/17

(52) U.S. Cl. 160/271

(57) ABSTRACT

When a fitting piece slipping out of a rail groove of a guide rail in connection with an excessive load on a shutter curtain is restored to the rail groove, the restoration is set to be reliably and noiselessly carried out. An posture holding bar 14 and fitting pieces 5 which are spaced from both right and left sides of the posture holding bar 14 at a predetermined interval are provided at the lower end portion of the shutter curtain 1, and a first guide body 15 for guiding the posture holding bar 14 to the opposing site to the rail groove 9a in the process of an opening/closing operation of the shutter curtain 1, and a second guide body 16 for guiding the fitting piece 5 at the lower end portion of the shutter curtain 1 to the opposing site to the rail groove 9a in conformity with a timing at which the posture holding bar 14 is positionally regulated to the opposing site to the rail groove 9a by the first guide body 15 are provided at the upper side of the rail groove 9a constituting the guide rail 4.

### TECHNICAL FIELD

The present invention belongs to the technical field of a sheet shutter device having a flexible shutter curtain provided at an opening portion of an architectural structure or the like.

### BACKGROUND ART

There is generally known such a type of sheet shutter device wherein engaging pieces are secured to both side portions of a sheet-shaped shutter curtain so as to be spaced at a predetermined pitch in the opening/closing direction, and the engaging pieces are engagingly fitted in rail grooves of guide rails at both side portions of the opening portion so as not to be detachable from the rail grooves and are made to run within the rail grooves, thereby opening/closing the opening portion. In this type of sheet shutter device, because the shutter curtain is formed of a sheet member having flexibility, the shutter curtain is greatly deformed when a large wind blast or a load from an obstruction is applied thereto, so that the guide rail or shutter curtain may be damaged.

As a countermeasure to this problem, there is known a sheet shutter device having such a structure that rail grooves of guide rails are designed to be flexible and the engaging pieces are disengaged from the rail grooves in such a case that an excessive load exceeding a predetermined load is applied to the shutter curtain. The structure described above requires work of returning the temporarily-disengaged engaging pieces to the rail grooves again, however, this work is not only cumbersome and troublesome, but also requires an overhead working. Therefore, there has been proposed such a type that the engaging pieces are automatically restored to a state where they are engagedly fitted in the rail grooves. As one such type of shutter device there is known a shutter device wherein bone members which are harder than the sheet material of a shutter curtain and retain the posture of the shutter curtain at a plurality of places in the opening/closing direction are disposed integrally with a sheet-shaped shutter curtain having flexibility in the width direction, engaging pieces which are engagedly fitted in rail grooves are provided at both end portions of the bone members, auxiliary guides intercommunicating with the rail grooves from the outside of the rail grooves are formed integrally at the open-side end portions of the flexible rail grooves, and the engaging pieces are automatically engagedly fitted in the rail grooves via the auxiliary guides in the process of closing the shutter curtain in which the engaging pieces slip out of the guide rails (Japanese Published Patent No. 2884103).

In the conventional shutter device, the end portions of the bone members as well as the engaging pieces are engagedly fitted in the rail grooves and thus the opening/closing sound is intense, the rail grooves are liable to be worn because the end portions of the bone members are in friction with the rail grooves, and also the magnitude of the load when the fitting pieces slip out of the rail grooves varies with time lapse. Furthermore, when the fitting pieces getting out of the rail grooves are automatically restored into the rail grooves, a plurality of bone-member end portions continuously and strongly abut against the auxiliary guides, so that the abutting sound is intensified and thus ambient noise occurs.

### DISCLOSURE OF THE INVENTION

The present invention has been implemented in view of the foregoing situation and to solve the above problems, and according to the invention of claim 1, in a sheet shutter device in which fitting pieces are provided at both side portions of a sheet-shaped shutter curtain so as to be spaced from one another at a predetermined pitch in a vertical direction and made to run while engagedly fitted in rail grooves of guide rails provided at both side portions of an opening portion, thereby opening/closing the opening portion, the rail grooves designed so that the fitting pieces come off from the rail grooves under an excessive load imposed on the shutter curtain, wherein an posture holding bar is provided to at least the lower end portion of the shutter curtain so as to be spaced from the fitting pieces in the curtain width direction, and at the upper side of each of the rail grooves are provided a first guide body for guiding the posture holding bar to an opposing part to each of the rail grooves and a second guide body for guiding the fitting piece at the lower end portion of the shutter curtain to an opposing part to each of the rail grooves in conformity with a timing at which the posture holding bar is guided to the opposing part to the rail groove by the first guide body are provided at the upper side of each of the rail grooves.

With this construction, the fitting piece coming off out of the rail groove can be set to a restored state under which it is engagedly fitted in the rail groove, in the process of the opening/closing operation of the shutter curtain. However, the posture holding bar is prevented from abutting against the rail groove and also the fitting piece is reliably guided.

According to the invention of claim 2, in claim 1, the second guide body is formed to be longer in the vertical direction than the pitch of the fitting pieces. With this construction, the guidance of the fitting piece to the opposing site to the rail groove can be further reliably carried out.

According to the invention of claim 3, in claim 1 or 2, a third guide body for guiding the fitting pieces to the opposing part to each of the rail grooves is provided between the upper end portion of the rail groove and the first guide body. With this construction, the opening/closing operation of the shutter curtain can be smoothly performed.

According to the invention of claim 4, in claim 3, the third guide body is provided with a freely deformable piece which is deformable perpendicularly to the curtain face. With this construction, when the fitting piece slipping out of the rail groove is displaced to the second guide body side, the third guide body is prevented from getting in the way.

According to the invention of claim 5, in any one of claims 1 to 4, the first guide body has a pair of guide faces for guiding the posture holding bar to the opposing part to the rail groove, and guideways which are inclined-shaped and guide the posture holding bar to the guide face are formed on the guide face at the upper and lower sides. With this construction, the guidance of the posture holding bar to the guide face can be smoothly and reliably performed.

According to the invention of claim 6, in claim 5, the freely deformable piece of the third guide body is formed so as to be located in an opposing gap between the guide surfaces at the lower side of the first guide body. With this construction, the opening/closing operation can be smoothly performed, and the fitting piece coming off from the rail groove can be reliably restored to the original state.

According to the invention of claim 7, in any one of claims 1 to 6, the first and second guide bodies are integrally formed with each other. The number of parts can be reduced, and the structure can be simplified.

According to the invention of claim 8, in claim 7, a step face for regulating the position in the right-and-left direction of the posture holding bar is formed between the guide face of the first guide body and a fitting piece guide portion which is formed in the second guide body and guides the fitting pieces to the opposing sites to the rail groove. With this construction, the position regulation of the posture holding bar in the right-and-left direction can be performed.

According to the invention of claim 9, in claim 8, a curtain guide face for guiding both right and left side edge portions of the shutter curtain is formed in the fitting piece guide portion of the second guide body. With this construction, further posture correction of the shutter curtain can be performed.

According to the invention of claim 10, in any one of claims 1 to 9, the guide rail comprises a support rail fixed to each of both sides of the opening portion, a rail body which is engaged with the fitting pieces and supported so as to be freely displaced to the inside of the opening portion with respect to the support rail, and urging means for urging outwardly the rail body displaced to the inside of the opening portion in connection with a load imposed on the shutter curtain, the urging means comprises an elongated elastic member disposed along the outer surface of the support rail, an elongated receiving plate member applied to the outer surface of the elastic member and a joint member provided between the rail body and the receiving plate member so as not to come off, and an elastic deforming force of the elastic member acts on the rail body via the elongated plate member. With this construction, a large urging force can be secured without increasing the space of the guide rail, the use range of the sheet shutter device can be enlarged, and also the degree of freedom of adjusting the urging force can be improved.

According to the invention of claim 1, when the fitting piece comes off from the rail groove, the operation of restoring the fitting piece to the original state can be smoothly and noiselessly performed and also the restoration of the fitting piece to the original state can be reliably performed.

According to the invention of claim 2, the restoration of the fitting piece to the original state is further reliably performed, and the reliability of the sheet shutter device can be enhanced.

According to the invention of claim 3, the opening/closing operation of the shutter curtain can be smoothly performed.

According to the invention of claim 4, the restoration of the fitting piece coming off from of the rail groove to the original state can be reliably performed although the device carries out a smooth opening/closing operation.

According to the invention of claim 5, the guidance of the posture holding bar to the guide face can be smoothly and reliably performed.

According to the invention of claim 6, the restoration of the fitting piece coming off from the rail groove to the original state can be reliably performed although the device carries out a smooth opening/closing operation.

According to the invention of claim 7, the number of parts can be reduced, and the structure can be simplified.

According to the invention of claim 8, the positional regulation of the posture holding bar in the right-and-left direction can be performed.

According to the invention of claim 9, further posture correction of the shutter curtain can be performed.

According to the invention of claim 10, the urging force can be strengthened without increasing the space of the guide rail. Therefore, the user range of the sheet shutter device can be enlarged, and also the degree of freedom of adjusting the urging force can be improved.

### BRIEF DESCRIPTION OF THE DRAWINGS

FIG. 1 is a front view showing the schematic overall structure of a sheet shutter device.

FIG. 2 is a planar cross-sectional view of the guide rail portion under a normal use state.

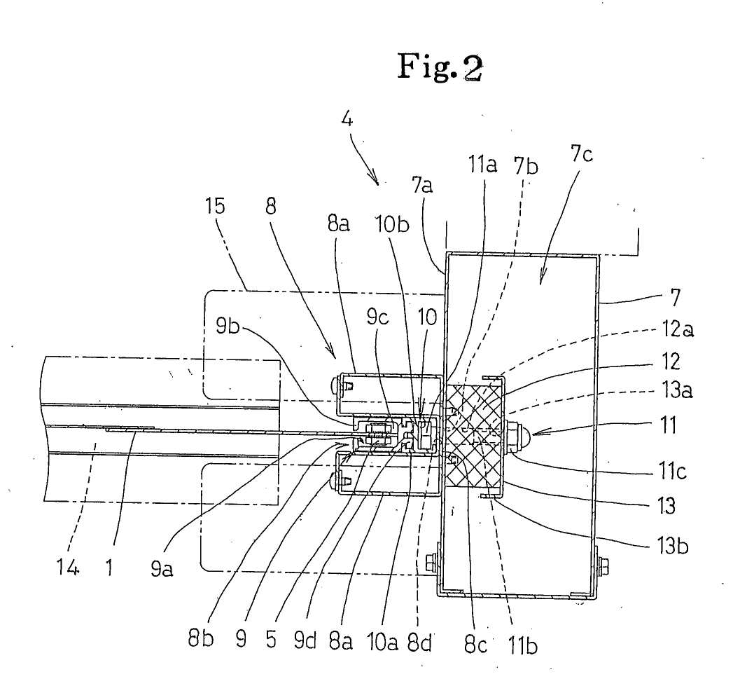

FIG. 3 is a planar cross-sectional view showing the guide rail portion to explain a state where a rail body is pulled.

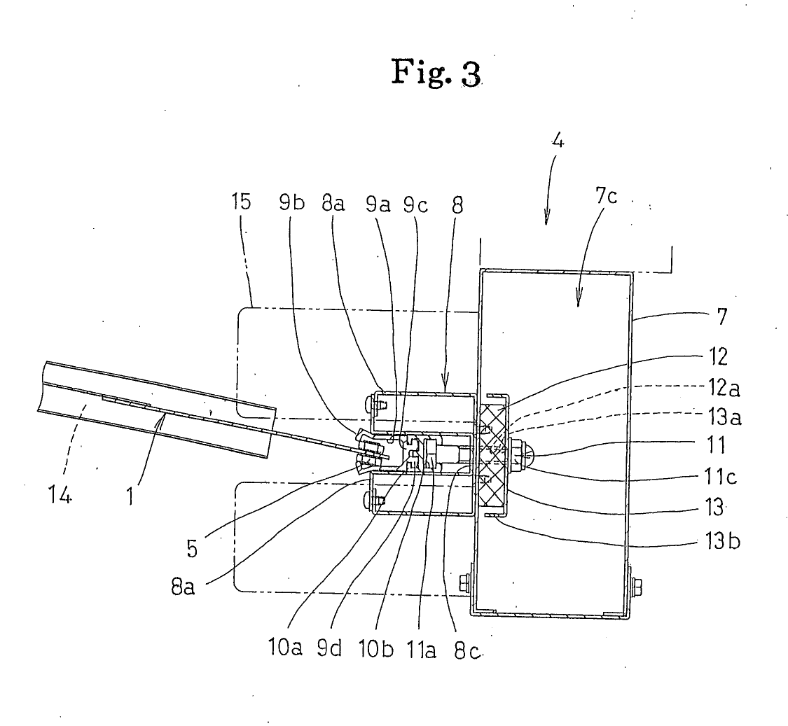

FIG. 4 is a side view showing the guide rail portion to explain a state where a part of the rail body is pulled.

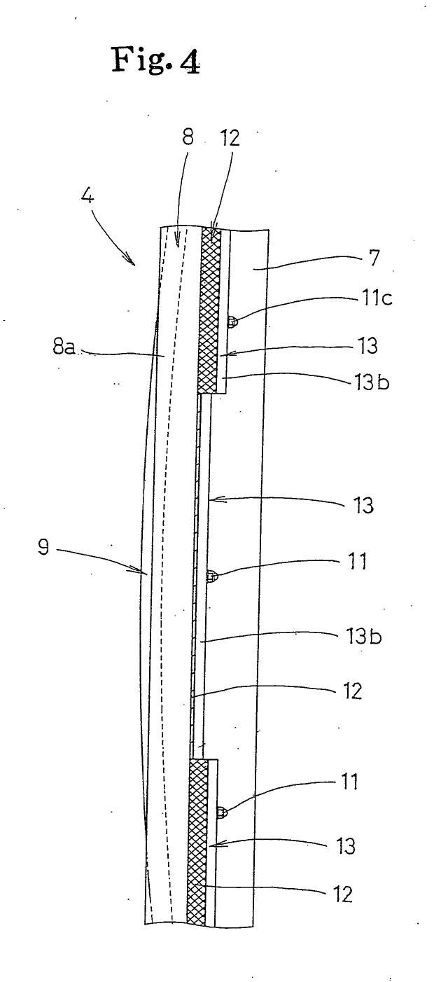

FIG. 5 is a side view of an upper end portion of the guide rail.

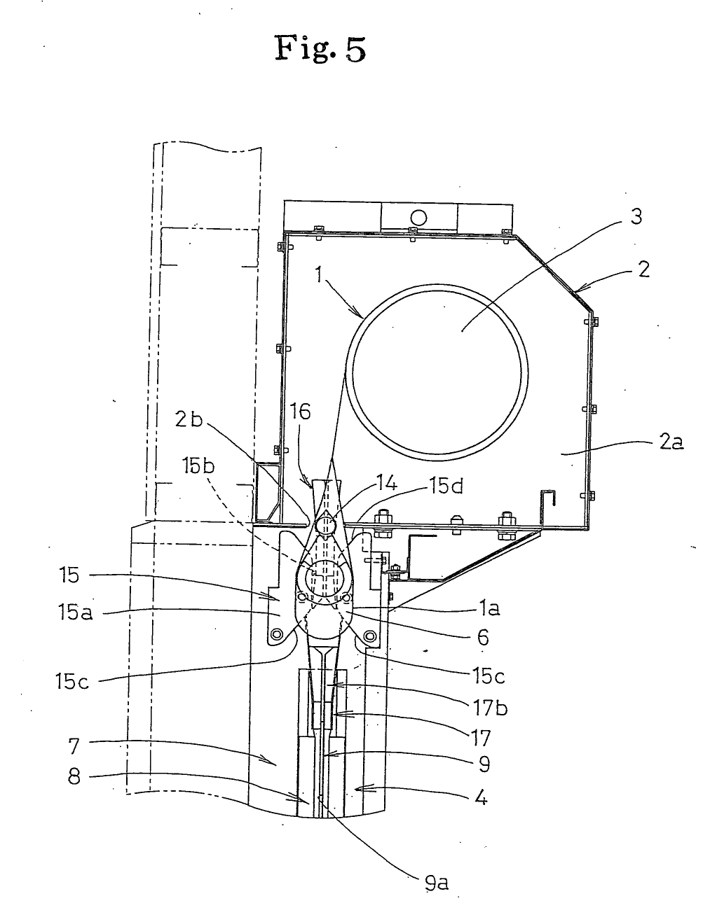

FIG. 6 is a front view of the upper end portion of the guide rail.

FIGS. 7(A), (B) and (C) are a plan view, side view and front view of a third guide body respectively.

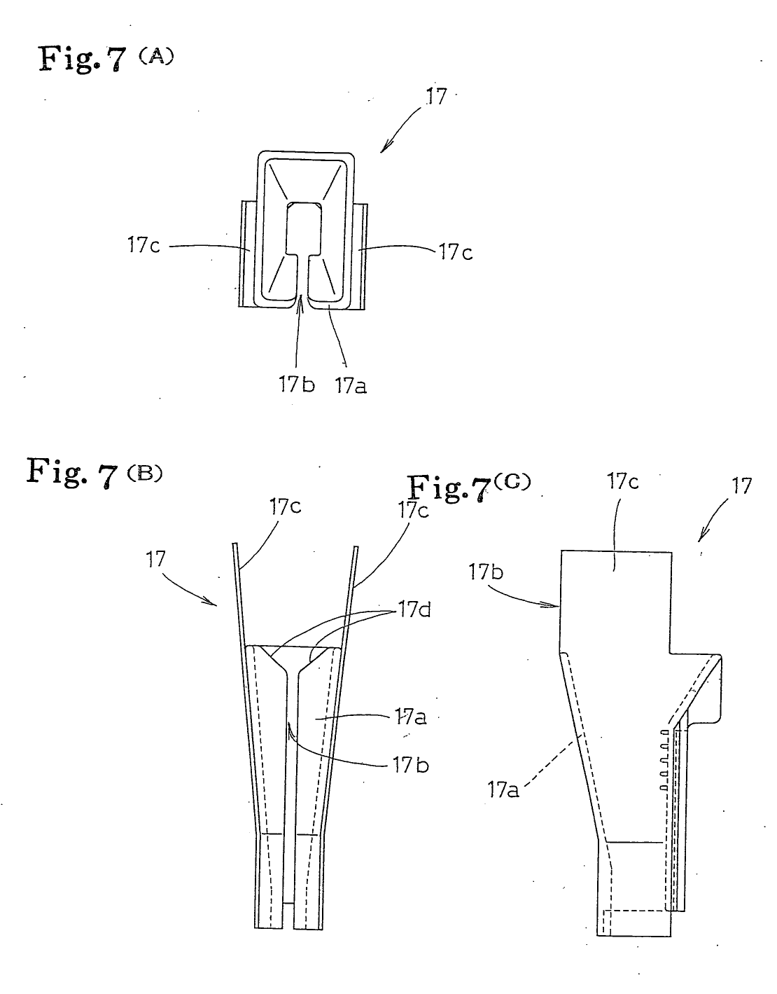

FIG. 8 is an enlarged front view of the main part.

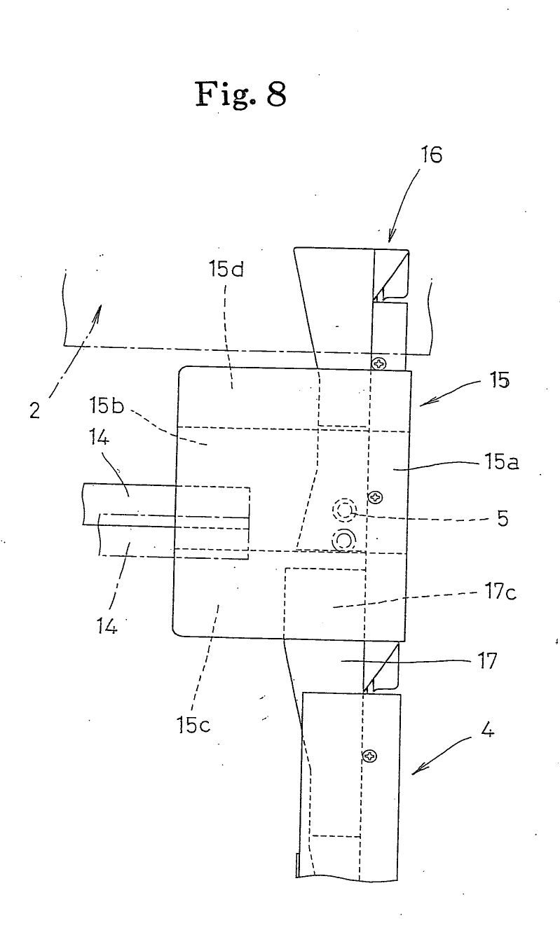

FIG. 9 is an enlarged side view of the main part.

FIG. 10(A) and (B) are planar cross-sectional views of a guide rail portion according to a second embodiment.

FIG. 11 is a perspective view showing a sheet shutter device according to a third embodiment.

FIG. 12 is a side view showing an arrangement state of a sensor group of the third embodiment.

FIG. 13 is a block diagram showing the control state of a controller according to the third embodiment.

FIG. 14 is a flowchart showing a control procedures of the controller according to the third embodiment.

FIG. 15 is a flowchart showing the control procedures of opening control in the controller of the third embodiment.

FIG. 16 is a flowchart showing the control procedures of closing control in the controller of the third embodiment.

FIG. 17 is a front view showing the overall structure of a sheet shutter device according to a fourth embodiment.

FIG. 18 is a side view showing the sheet shutter device according to the fourth embodiment.

FIGS. 19(A) and (B) are planar cross-sectional views of the guide rail portion according to the fourth embodiment.

FIG. 20 is a partial front view showing the operation of the guide rail of the fourth embodiment.

FIGS. 21(A), (B) and (C) are a plan view, front view and side view showing a fourth guide body of the fourth embodiment respectively.

FIG. 22 is a flowchart showing the control procedures of the opening control in a controller of a fifth embodiment.

FIG. 23 is a flowchart showing the control procedures of the closing control in a controller of a sixth embodiment.

### BEST MODES FOR CARRYING OUT THE INVENTION

A first embodiment according to the present invention is described with reference to the drawings.

In the figures, 1 denotes a shutter curtain of the sheet shutter device for opening/closing the opening portion of an architectural structure. The shutter curtain 1 is formed of a flexible sheet material, and wound around the outer periphery (outside) of a winding drum (take-up drum) 3 which is rotatably supported via a shaft on the right and left side plates 2a of a shutter case 2 disposed at a ceiling portion of a structure frame (at the curtain opening side of the structure frame). The shutter curtain 1 is wound off from or taken up to the winding drum 3 in connection with forward/reverse rotation of the winding drum 3 based on an opening/closing operation of an opening/closing unit (not shown), thereby opening/closing the opening portion. At this time, both right and left side edge portions of the shutter curtain 1 are vertically moved while guided by a pair of guide rails 4 erectly equipped at both sides of the opening portion in the opening width direction (right-and-left direction).

Shutter curtain 1 is integrally provided with fitting pieces 5 at the right and left side edge portion thereof, which are spaced from one another at a predetermined interval in the vertical direction. The fitting pieces 5 are set to be movably fitted in the rail grooves 9a of the guide rail 4, which will be described later, so as to be prevented from slipping out of the rail grooves. The lower end edge portion of the shutter curtain 1 is designed in a bag-shaped portion by folding the sheet material of the shutter curtain 1, and a pair of right and left bottom weights 6 are installed in both end portions in the right-and-left direction of the bag-shaped portion 1a. Accordingly, the bottom weights 6 act as poises at the lower end portion of the shutter curtain 1, so that the shutter curtain 1 can be smoothly operated during the closing operation of the shutter curtain 1 and impact can be absorbed when it abuts against an obstruction.

The guide rails 4 provided at both side portions of the opening portion are equipped with hollow fixing metal brackets 7 which are integrally fixed to both right and left sides of the opening portion of the structure frame in the vertical direction.

A support rail 8 is provided with a pair of front and rear (indoor and outdoor) support piece portions 8a which are spaced from each other at a predetermined interval and are integrally fixed to one side piece 7a of each fixing bracket 7a at the opening portion side. Each support rail 8 is formed by bending a metal plate material, and a recess groove portion 8b is formed in the gap between the opposing sides of the pair of support piece portions 8a, and the bottom piece portion 8c of the recess groove portion 8b and the side surfaces of the support piece portions 8a which are located on the same plane as the bottom piece portion 8c are pressed against the one side piece 7a of each fixing bracket 7 and fixed to the fixing bracket 7 by a screw.

A rail body 9 which is designed to be elongated in the vertical direction is attached to the recess groove portion 8b of each support rail 8 so as to be freely movable in the right-and-left direction. The rail body 9 is integrally molded by using flexible resin material, and designed so as to be opened at the opening portion side and have a rail groove 9a in which fitting pieces 5 equipped to the shutter curtain 1 are engagedly fitted. Come-off-preventing pieces 9b for preventing coming out of the fitting pieces 5 from the rail grooves 9 are formed at the opening portion of the rail grooves 9a. Under the state that the rail body 9 is located in each support rail recess groove portion 8b and deformation of each rail groove 9a is regulated by the support piece portion 8a, the come-off-preventing piece 9b prevents the fitting pieces 5 from coming off from the rail groove 9a. On the other hand, as described later, when the fitting pieces 5 pull the rail body 9 inward to the opening portion and thus slide from the support rail recess groove portion 8b by a predetermined displacement amount, so that the fitting pieces 5 come off from the support rail recess groove portion 8b, the regulation of the deformation of the rail groove 9a by the support piece portion 8a is lost, and thus the rail groove 9a is deformed, so that the fitting pieces 5 come off from the rail groove 9a.

Furthermore, an elongated auxiliary rail 10 is disposed between the rail body 9 and the support rail bottom piece portion 8c, and an engaged piece 10a projected to the opening portion side of the auxiliary rail 10 is engaged with an engaging piece 9d which is formed at the groove bottom portion 9c of the rail body rail grove 9a so as to project toward the structure frame side, whereby the rail body 9 and the auxiliary rail 10 are set to work integral with each other with respect to the movement of the right-and-left directions. A recess portion 10b opened at the structure frame side is formed in the auxiliary rail 10, and a bolt head 11a of a long bolt 11 corresponding to a joint member of the present invention is engaged with the recess portion 10b so as to prevent coming off. Plural long bolts 11 are engaged with the auxiliary rail 10 so as to be spaced from one another at a predetermined interval in the rail longitudinal direction (vertical direction), and shaft portions 11b of the long bolts 11 which project to the structure frame side penetrate through holes 8d and 7b formed so that the support rail bottom piece portion 8c and the fixing bracket one side piece 7a intercommunicate with each other via these through holes, and extend to the inside of the hollow portion 7c of the fixing metal bracket 7.

Furthermore, an elastically deformable buffer member 12 is equipped over the whole length in the longitudinal direction along the outer surface of the one side piece 7a (the outer surface of the opening portion) in the hollow portion 7c of the fixing bracket 7. The buffer member 12 is cut into a plurality of parts in the vertical direction in accordance with the number of the long bolts 11, and each long bolt shaft portion 11b is set to penetrate through hole 12a formed at the center portion of each buffer member 12. Here, any member may be used as the buffer member 12 insofar as it is elastically deformable (restorable deformation) and also can be equipped over the whole length along the one side piece 7a. For example, it may be structured by forming a high-density resin material in an elongated rectangular shape. In this embodiment, a hard sponge is adopted.

A receiving plate member 13 which is formed in accordance with the vertical length of the buffer member 12 is allocated to the outer surface of each buffer member 12, and the long bolt shaft portion 11b projecting from the buffer-member through hole 12a penetrates a through hole 13a formed in the receiving plate member 13 so that each nut is screwed together at one end portion of the through hole 13a. Accordingly, the long bolt 11 is set so as to be prevented from coming off over the area extending from the rail body 7 to the receiving plate member 13.

Here, the nut 11c is designed to be threaded with the long bolt 11 until the nut 11c receives proper elastic force from the buffer member 12. Accordingly, the rail body 9 is urged toward outside of the opening portion, and maintained in a normal guide position where it is located at the side of the bottom piece portion 8c of the support rail 8 via the auxiliary rail 10. The receiving plate 13 is formed of material having proper flexibility and, for example, it is formed of spring material, metal material such as steel or the like.

In the guide rail 4 thus structured, at the time of doing the opening/closing operation in connection with the wind-up or wind-out operation of the shutter curtain 1 or during a fully closing operation, when a load is imposed on the shutter curtain because wind is blown to the shutter curtain 1 or an obstruction abuts against the shutter curtain, the load thus imposed pulls the rail body 9 via the fitting pieces 5 toward inside of the opening portion and the buffer member 12 receives the pulling force via the long bolts 11.

If the load imposed on the shutter curtain 1 is small and the sliding displacement amount of the rail body 9 caused by deformation of the buffer member 12 is within such a range that the support rail support piece portion 8a can prevent deformation of the rail groove 9a, the fitting pieces 5 are prevented from coming off from the rail groove 9a. When the load is large (excessive load state) and the buffer member 12 is greatly deformed so that the rail groove 9a is pulled while the displacement amount exceeds the sliding displacement amount, the regulation of the deformation of the rail groove 9a by the support rail support piece portion 8c is lost, so that the rail groove 9a is deformed and the fitting pieces 5 come off from the rail groove 9a.

The coming-off load is preset on the basis of the shape such as the thickness, hardness, cross-sectional area, etc., of the buffer member 12 and further on the basis of the shape such as the thickness, cross-sectional area, length, etc., of the receiving plate member 13, whereby the degree of freedom to adjust the coming-off load can be increased.

That is, in this embodiment, the buffer member 12 which receives some load in connection with pulling of the shutter curtain 1 is designed to be long in the rail longitudinal direction, and also the buffer member 12 is equipped with the receiving plate member 13. Accordingly, the long bolts 11 which are equipped so as to be spaced from one another in the rail longitudinal direction receive elastic deforming force over the whole length of the buffer member 12 via the receiving plate member 13, and urges the rail body 9 outward from the opening portion by the elastic deforming force thus received. Therefore, as described above, the urging force acting on the rail body 9 by the long bolts 11 corresponds to the elastic deforming force over the whole length of the elongated buffer member 12, and thus it can cope with the load imposed on the shutter curtain 1 while serving as a stronger urging force than when a coil spring is wound around a conventional long bolt 11 to apply a local urging force to the long bolt 11. Accordingly, the urging force can be magnified without increasing the space of the guide rail, and the use range of the sheet shutter can be enlarged.

In this shutter device, each receiving plate member 13 is formed of a flexible plate material, and designed so that flexibility occurs therein when it is pulled at a place where the corresponding long bolt 11 is disposed. Accordingly, the urging force acting on the rail body 9 is set to be the resultant force of the elastic deforming force of the buffer member 12 and the flexible force of the receiving plate member 13. Therefore, the coming-off preventing load of the fitting pieces 5 of this embodiment can be adjusted by the strength of the elastic deforming force of the buffer member 12 and the flexible force of the receiving plate member 13, and the coming-off preventing load of the fitting pieces 5 can be set on the basis of this strength, so that the degree of freedom of adjusting the urging force can be improved.

The adjustment based on the buffer member 12 is carried out by varying the hardness and thickness of the buffer member 12 or varying the length thereof with respect to the length of the long bolts 11, and the adjustment based on the receiving plate member 13 is carried out by varying the length thereof with respect to the buffer member 12 and the thickness of the plate member.

Reinforcing pieces 13b which are bent to the buffer member 12 side are integrally formed at both side edge portions of the receiving plate member 13 in the longitudinal direction to thereby enhance the strength of the flexibility of the receiving plate member 13. By varying the bent length of the reinforcing pieces, the flexible force of the receiving plate member 13 can be adjusted.

As described above, the bottom weights 6 are equipped at the lower end portion of the shutter curtain 1, and an posture holding bar 14 for holding the posture of the shutter curtain 1 is also equipped at the lower end portion of the shutter curtain 1. The posture holding bar 14 is used to maintain the posture of the sheet-shaped shutter curtain 1 in the width direction. It is designed so as to extend to the outside area in the right-and-left direction (curtain width direction) of the area where bottom weights 6 are disposed, and so that the length thereof is shorter in length than the whole width of the shutter curtain 1 and does not extend to both right and left end portions of the shutter curtain 1 at which the fitting pieces 5 are equipped. Accordingly, the posture holding bar 14 is prevented from being engaged with the rail grooves 9a of the guide rails 4. Furthermore, the fitting pieces 5 are provided at both right and left end portions of the shutter curtain 1 which correspond to right and left sides of the posture holding bar 14 so as to be spaced from the posture holding bar 14 at predetermined intervals.

A curtain entrance/exit portion 2b serving as an entrance/exit portion of the shutter curtain 1 wound off from the winding drum 3 is formed at the lower side of the shutter case 2, and first, second and third guide bodies 15, 16, 17 practiced by the present invention are provided between both right and left end portions of the entrance/exit portion 2b and the upper end portions of the right and left guide rails 4 so that the opening/closing operation of the shutter curtain 1 can be smoothly carried out and also when the fitting pieces 5 come off from the rail grooves 9a, the fitting pieces 5 can be engagedly fitted in the rail grooves in connection with the opening/closing operation of the shutter curtain 1, thereby restoring the fitting pieces 5 to the original state.

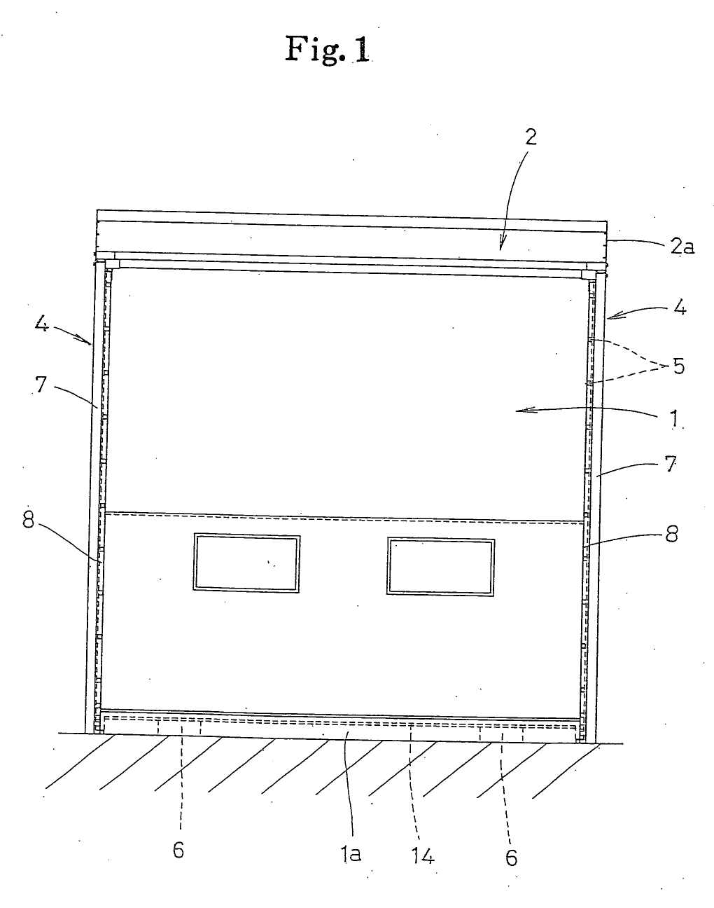

These first, second and third guide bodies 15, 16, 17 are secured to the corresponding places at both right and left sides. However, as a matter of convenience, only the first, second and third guide bodies 15, 16, 17 at the right side in FIG. 1 will be described, and description of these bodies at the left side is omitted from the following description.

That is, a gap is formed between the curtain entrance/exist port 2b and the upper end portion of the rail groove 9a of the pair of guide rails 4, and the first guide body 15 for guiding (positionally regulating) the posture holding lever 14 equipped to the lowermost end of the shutter curtain 1 to the site opposing the rail groove 9a is equipped in the gap. The first guide body 15 is formed of resin material having no flexibility (resin material having flexibility may be used), and comprises a pair of guide pieces 15a for clamping the end portion of the posture holding bar 14 from the front and rear sides. Each guide piece 15a is fixed to one side piece 7a of the fixing bracket 7 so as to provide a predetermined opposing gap in the front-and-rear directions. Each guide piece 15a projects so as to be nearer to the opening portion side than the support rail 8 constituting the guide rail 4 and so that opposing faces are formed so as to face the end portions of the posture holding lever 14 from the front-and-rear directions. The opposing faces located at the intermediate position in the vertical direction are formed on the guide faces 15b which are formed so that the opposing interval thereof is slightly larger than the outer diameter of the posture holding bar 14. The opposing face of each guide piece 15a has a lower side guide face 15c which is continuous to the lower side of the guide face 15b and inclined so that the opposing interval is increased toward the lower side, and an upper guide face 15d which is continuous to the upper side of the guide face 15b and inclined so that the opposing interval is increased toward the upper side.

The second and third guide bodies 16, 17 are arranged in the vertical direction between the opposing guide pieces 15a of the first guide body 15. The second guide body 16 is formed of resin material having flexibility as in the case of the rail body 9, and a guide groove 16b having the same coming-off preventing pieces 16a is integrally formed in the vertical direction. The second guide body 16 is set to have such a vertical positional relationship that the lower end edge thereof is substantially coincident with the lower end edges of the first guide body guide faces 15b, and the upper end edge thereof is provided so as to extend from the curtain entrance/exit portion 2b into the shutter case 2. The second guide body 16 is designed so that the groove width is widened to the upper and lower ends (the length is lengthened in the front-and-rear directions) and the length in the right-and-left direction is lengthened, and also guide faces 16c whose opposing gap is further reduced to the upper side thereof are formed at the lower end edges of the coming-off preventing pieces 16a.

The third guide body 17 is formed of flexible resin material as in the case of the second guide body 16 and rail body 9, and a guide groove 17b having an coming-off preventing piece 17a like the rail groove 9a is integrally formed in the vertical direction. The third guide body 17 is disposed in such a vertical positional relationship that the upper end edge is substantially coincident with the lower end edge of the first guide body 15, and the lower end edge is integrally joined so as to be fitted over the upper end portion of the rail groove 9a while the third guide groove 17b and the rail groove 9a intercommunicate with each other. Furthermore, freely-deformable pieces 17c are formed at the upper end edge of the third guide body 17 so as to extend from the front-and-rear side pieces. The freely-deformable pieces 17c are more flexible than the third guide body 17, and displaced in the front-and-rear directions (the direction perpendicular to the curtain face) by press force of the fitting pieces 5 described later. The freely-deformable pieces 17c are located in the opposing gap between the lower side guide faces 15c of the first guide body so that the upper end edges thereof extend to the lower side guide faces 15c and oppose the lower end portions of the second guide body 17 in proximity to the lower end portions. The third guide body 17 is designed so that the groove width is increased and also the length thereof in the right-and-left direction is lengthened to the upper end, and guide faces 17d whose gap is increased to the upper side thereof are formed at the upper end edges of the coming-off preventing pieces 17a.

When an excessive load acts on the shutter curtain 1 located at the opening portion and the fitting pieces 5 located at the intermediate portion in the vertical direction of the shutter curtain come off from the guide groove 9a of the guide rail 4 while the fitting pieces 5 located at the right and left side portions of the posture holding bar 14 do not come off from the guide groove 9a, the shutter curtain 1 at the sites corresponding to the fitting pieces 5 thus come off is freely wound around the winding drum 3 by carrying out an opening operation of the shutter curtain 1. At this time, because the posture holding bar 14 and the fitting pieces 5 located at the right and left sides thereof do not come off from the guide rails 4 they are displaced to the winding drum 3 side via the first guide 15 or the second and third guide bodies 16, 17.

On the other hand, when the posture holding bar 14 and the fitting pieces 5 located at the right and left side portions thereof come off from the guide rails 4, the fitting pieces 5 which are located at higher positions than the posture holding lever 14 and come off from the guide rails 4 are freely wound up around the winding drum 3 by opening the shutter curtain 1 as described above, and thus the fitting pieces 5 are not necessarily required to be engagedly fitted in the second guide groove 16c.

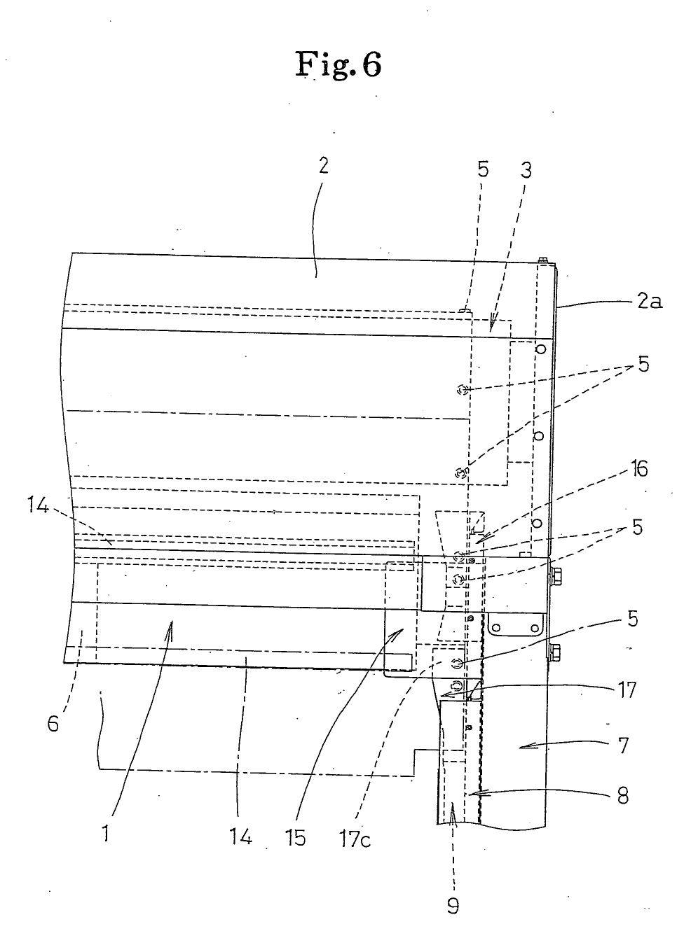

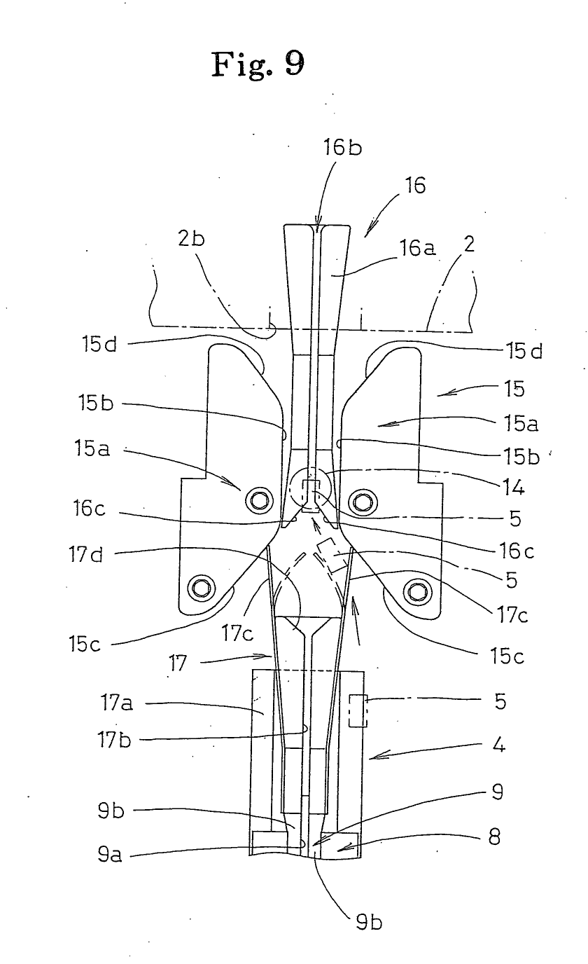

When the posture holding bar 14 coming off from the guide rail 4 is upwardly moved, the posture holding bar 14 abuts against any one of the front and rear lower side guide faces 15c of the first guide body 15 and is guided to the guide face 15b side. Here, the maximum opposing gap (groove width) between the lower-side guide faces 15c of the first guide body 15 is set from the maximum displacement amount of the posture holding lever 14 based on the shutter curtain 1 amount fed from the case entrance/exit portion 2b, and the posture holding bar 14 interferes with the lower side guide faces 15c even under the state that the fitting pieces 5 of the lower end portion come off from the guide rail 4. At this time, the fitting pieces 5 which are located at the lower end portion and at the right and left side portions of the posture holding bar 14 are located in the vicinity of the upper portion of the third guide body 17. Therefore, the posture holding bar 14 is displaced to the guide face 15b side while guided by the lower side guide faces 15c, and in connection with this displacement of the posture holding bar 14, the fitting pieces 5 press the freely deformable pieces 17c as indicated by an virtual line of FIG. 9, and guides the freely deformable pieces 17c to the second guide groove 16c side while deforming the freely deformable pieces 17c. The fitting pieces 5 of the lower end portion reach the lower side of the second guide groove 16c in conformity with the timing at which the posture holding bar 14 reaches the guide faces 15b and is guided so as to regulate the position in the front-and-rear directions (posture correction) (see the virtual line of FIG. 6).

That is, the posture holding bar 14 carries out the positional regulation in the right-and-left direction of the shutter curtain 1 (holding the posture), and also it is guided (positionally regulated) in the front-and-rear directions by the first guide body 15, whereby the fitting pieces 5 which are located at the right and left sides of the posture holding bar 14 and also at the lower end portion of the shutter curtain 1 are positioned to the lower end portion of the second guide grove 16c while guided in the front-and-rear directions and the right-and-left direction. Therefore, under this posture state, the shutter curtain 1 is further opened, whereby the fitting pieces 5 of the lower end portion are reliably engagedly fitted in the second guide groove 16c and thus the guidance to the opposing site to the rail groove 9c can be reliably carried out. Here, the second guide body 16 is designed so that the groove width is increased to the lower end portion and the guide faces 16c are formed at the lower end portions of the slipping out pieces 16a. Therefore, the fitting pieces 5 are guided to the second guide groove 15b and thus the engagement of the fitting pieces 5 can be reliably carried out.

As described above, the fitting pieces 5 which are located at the lower end portion of the shutter curtain 1 and also at the sides of the posture holding bar 14 are engagedly fitted in the guide groove 16b of the second guide body 16 at the full open time of the shutter curtain 1 even when the fitting pieces 5 come off from the rail groove 9a at the opening portion. Accordingly, at least at the lower end portion of the shutter curtain 1, the fitting pieces 5 are restored to the state that they are engagedly fitted in the rail groove 9a.

When the closing operation is carried out on the shutter curtain 1 from the full-open state, at least the fitting pieces 5 which are located at the lower end portion and also at both sides of the posture holding bar 14 are engagedly fitted in the second guide grooves 16b and thus restored to the original posture. Therefore, when the closing operation is carried out on the shutter curtain 1, the shutter curtain 1 is downwardly moved in conformity with the posture of the lower end portion. Therefore, with respect to even the intermediate portion of the shutter curtain 1 taken up around the winding drum 3 while the fitting pieces 5 come off from the second guide groove 16b, the posture of the intermediate portion is restored while displaced between the winding drum 3 and the second guide body 16, and the fitting pieces 5 are engagedly fitted in the second guide groove 16b and guided to the opposing site to the rail groove 9a, whereby all the fitting pieces 5 located at the opening portion are engagedly fitted in the rail groove 9a by setting the shutter curtain 1 to the fully closed posture. Here, the length in the vertical direction of the second guide body 16 is set to be longer than the arrangement pitch of the fitting pieces 5 provided to the shutter curtain 1. Therefore, under the state that a precedent fitting piece 5 is engagedly fitted in the second guide groove 16b and guided to the opposing site to the rail groove 9a, the following fitting piece 5 is engagedly fitted in the second guide groove 16b, whereby all the subsequent fitting pieces 5 are engagedly fitted in the second guide groove 16b.

In the closing operation of the shutter curtain 1, the posture holding bar 14 is guided and moved to the guide faces 15b by the upper guide faces 15d of the first guide body 15, and the fitting pieces 5 fed from the winding drum 3 side pass from the upper end portion of the second guide body 16 having a large groove width via the second guide groove 16b and the third guide groove 17b of the third guide body 17 having a larger groove width to the rail groove 9a, whereby the fitting pieces 5 which are positionally regulated to the opposing sites to the rail groove 9a by downwardly moving the second guide body 16 are reliably guided to the rail groove 9a side to close the opening portion.

In the first embodiment of the present invention thus structured, the winding drum 3 is forwardly/reversely rotated by driving the opening/closing mechanism (not shown), and in connection with this rotation, the shutter curtain 1 carries out the opening/closing operation while the fitting pieces 5 at both side portions are engagedly fitted in the guide rails 4 and guided under the state that the coming-off is prevented. In this case, the rail body 9 constituting the guide rail 4 is designed to be freely movable in the right-and-left direction with respect to the support rail 8, and also the rail body 9 is designed to come off from the recess groove portion 8a of the support rail 8 when an excessive load acts on the shutter curtain 1. Accordingly, the shutter curtain 1 and the guide rails 4 are protected. Furthermore, the fitting pieces 5 are provided at the lower end portion of the shutter curtain 1 and the posture holding bar 14 is provided with the gap from the fitting pieces 5, and also the first, second and third guide bodies 15, 16, 17 are provided at the upper portion of the guide rails 4. When a fitting piece 5 comes off from the rail groove 9a of the guide rail 4, the fitting piece 5 at the lowermost end at which the posture holding bar 14 is provided is subjected to the posture holding in the right-and-left direction by the posture holding bar 14, and also the posture holding bar 14 is guided by the guide face 15b of the first guide body 15 in the process of the opening operation of the shutter curtain 1, thereby carrying out the positioning in the front-and-rear directions. Accordingly, the fitting pieces 5 which are located at the lower end portion and at both sides of the posture holding bar 14 are positioned in the right-and-left direction and in the front and rear direction, and forcedly positioned to the opposing sites to the rail grooves 9a, whereby the fitting pieces 5 are allowed to be restored to the rail grooves 9a. In this case, the posture holding bar 14 is designed so as not to be engagedly fitted in the rail grooves 9a. Therefore, the posture holding bar 14 does not interfere with the rail grooves 9a in the process of the opening/closing operation of the shutter curtain 1, the rail grooves 9a are prevented from being worn away, and thus the opening/closing operation can be carried out noiselessly. In addition, the posture holding bar 14 is provided so as to oppose at least the fitting pieces 5 at the lower end portion, whereby the fitting pieces 5 are guided to the opposing sites to the rail grooves 9a and under this state all the fitting pieces 5 are engagedly fitted in the rail grooves 9a by closing the shutter curtain 1, thereby restoring the fitting pieces to the original state. The restoring operation can be carried out noiselessly because the posture holding bar 14 does not interfere with the rail grooves 9a.

In addition, the fitting pieces 5 are engagedly fitted in the second guide grooves 16b provided at the opposing sites of the rail grooves 9a in conformity with the timing at which the posture holding bar 14 is guided in the front-and-rear directions by the first guide body 15, so that the engagedly fitting operation of the fitting pieces 5 to the second guide groove 16b can be reliably carried out, and the reliability of the restoration to the rail grooves 9a can be further enhanced.

Furthermore, because the length in the vertical direction of the second guide body 16 is longer than the arrangement pitch of the fitting pieces 5 of the shutter curtain 1, the next fitting piece 5 is guided toward the second guide groove 15b side during the period when the fitting piece 5 at the lower end portion is being guided to the second guide groove 15b in the process of the closing operation of the shutter curtain 1. Therefore, guidance of the fitting pieces 5 to the second guide groove 15b is made reliable, so that the guidance of the fitting pieces 5 to the confronting site to the rail groove 9a can be further reliably carried out.

Still furthermore, the third guide body 17 having the third guide groove 17b which closely intercommunicates with the second guide groove 16b is provided at the lower side of the second guide body 16, and the third guide groove 17b is provided so as to intercommunicate with the rail groove 9a. Therefore, the fitting piece 5 guided by the second guide groove 16b can reliably be guided via the third guide groove 17b to the rail groove 9a, thereby enhancing the reliability of the sheet shutter device.

In addition, the third guide body 17 is provided so as to be close to the second guide body 16 in the vertical direction, so that the guidance of the fitting pieces 5 to the opposing sites to the rail groove can be reliably performed. The freely-deformable pieces 17c are provided to the upper portions of the front and rear side pieces of the third guide body 17, and when the fitting piece 5 comes off from the guide rail 4, the freely deformable piece 17c is deformed, and displaced to the second guide body 16 side, so that the engagement restoring operation of the fitting piece 5 to the guide rail 4 can be smoothly performed.

Furthermore, the first guide body 15 is provided with the guide faces 15c, 15d for guiding the posture holding bar 14 to the guide face 15b side, and thus the guidance to the opposing site to the rail groove 9a is smoothly performed.

With respect to the structure of the guide rail 4 of this embodiment, the long bolt 11 joined to the rail body 9 is applied to the outer surface of the one side piece 7a of the fixing bracket 7 for fixing the support rail 8, and receives the elastic deforming force of the overall elongated buffer member 12 provided over the whole length in the vertical direction via the receiving plate member 13 applied from the outside of the buffer member 12, so that the rail body 9 is urged to the outside of the opening portion by the elastic deforming force received via the receiving plate member 13. Therefore, as compared with the conventional guide rail structure that the coil elastic piece is wound around the long bolt to apply a local urging force to the shutter curtain, a larger urging force can be applied to the shutter curtain.

In the conventional guide rail structure, when the urging force of the coil elastic piece is strengthened to provide a large coming off load so that the fitting piece 5 can be prevented from coming off due to air pressure acting on the shutter curtain 1, the coming off load is locally larger at the coil elastic piece disposed site, and thus there is a disadvantage that a fitting piece hardly comes off when an obstruction abuts against a shutter curtain and thus a large load partially acts on the shutter device. On the other hand, with respect to the guide rail 4 of this embodiment, the load acting on the shutter curtain 1 is received by the whole buffer member 12 elongated in the vertical direction, so that the coming off load is not locally increased, and thus the above disadvantage can be overcome. As a result, the sheet shutter device of this embodiment can be disposed not only in a room which is only slightly affected by wind, but also outdoors. Therefore, the use range of the sheet shutter device can be enlarged.

Furthermore, when the coming off load of the fitting piece 5 from the rail groove 9a is adjusted on the basis of the adjustment of the urging force applied to the rail body 9 via the buffer member 12 and the receiving plate member 13 by the long bolt 11 in the guide rail 4, the coming off load can be adjusted not only by adjusting the thickness, and hardness of the buffer member 12, but also by adjusting the length, and flexibility of the receiving plate member 13, so that the degree of freedom of adjusting the urging force can be greatly improved.

In addition, in this case, the elastic deforming force of the buffer member 12 over the whole length of the rail can be used as the urging force, and a large urging force can be secured. Therefore, a disadvantage such as a large-size design can be avoided, and the number of long bolts 11 is not required to be increased, so that the cost can be reduced.

A leaf spring or the like which is formed like a waveform may be used as the buffer member, and it may be designed as an elongated body over the whole length of the guide rail.

The receiving plate member may be provided with a plurality of elongated members which are disposed so as to be spaced from one another at predetermined intervals. Furthermore, the receiving plate member may be formed of a flexible material, and it may be designed as an elongated member extending over the whole length of the guide rail.

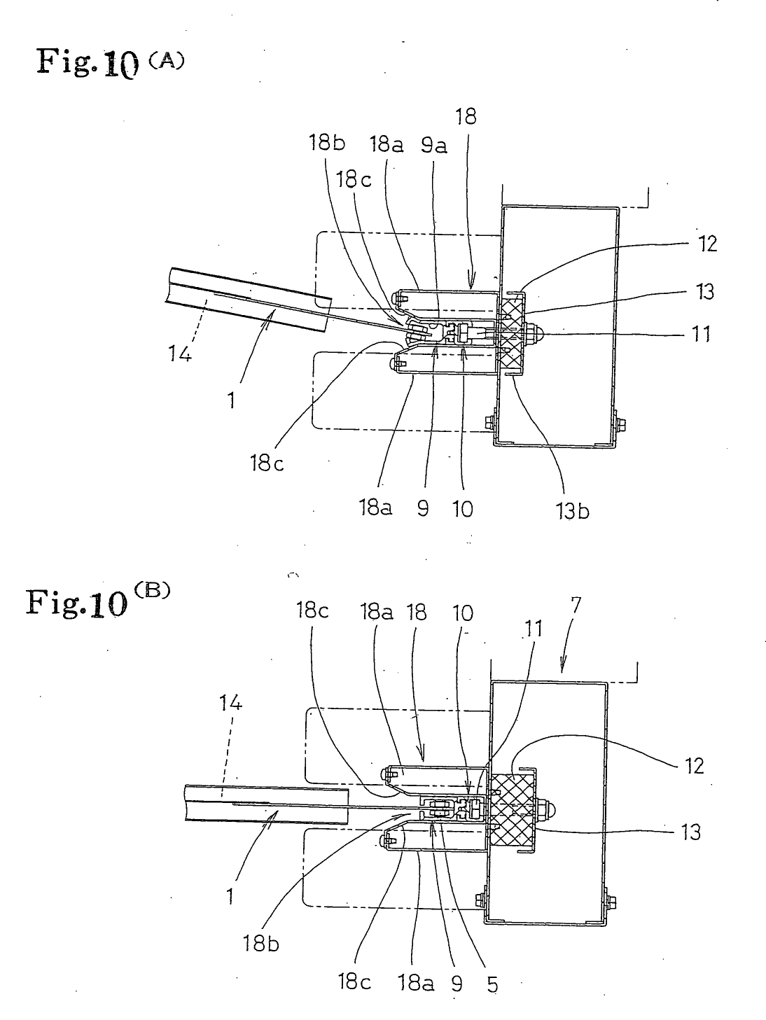

Next, a second embodiment will be described with reference to FIG. 10. In this embodiment, guide faces 18c for guiding the rail body 9 to the coming off side are formed at the groove opening portion of the recess groove portion 18b of a support rail 18 which is structured by a pair of guide pieces 18c. With this structure, when the support rail 18 is formed of metal and the rail body 9 is formed of resin material, the rail body 9 can be protected.

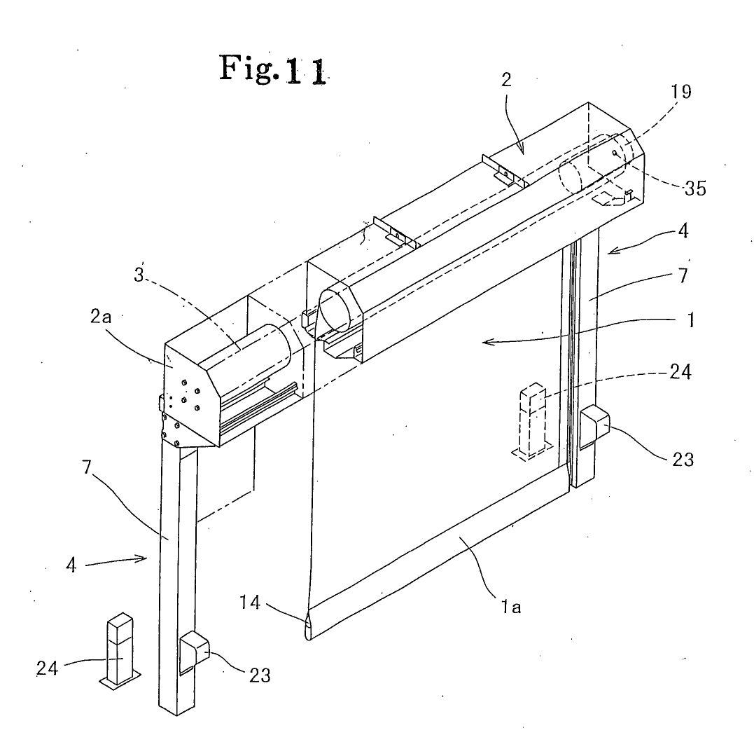

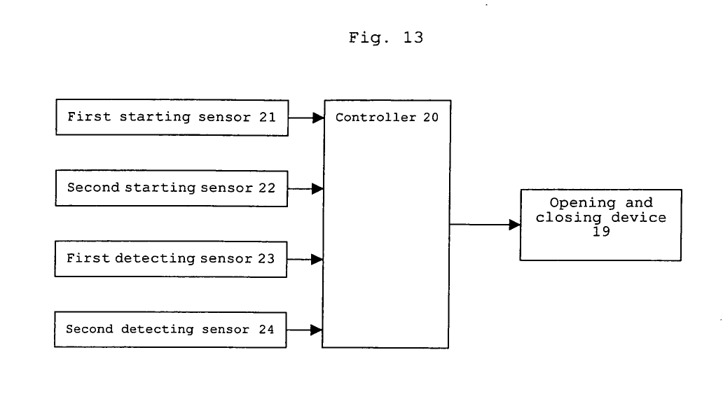

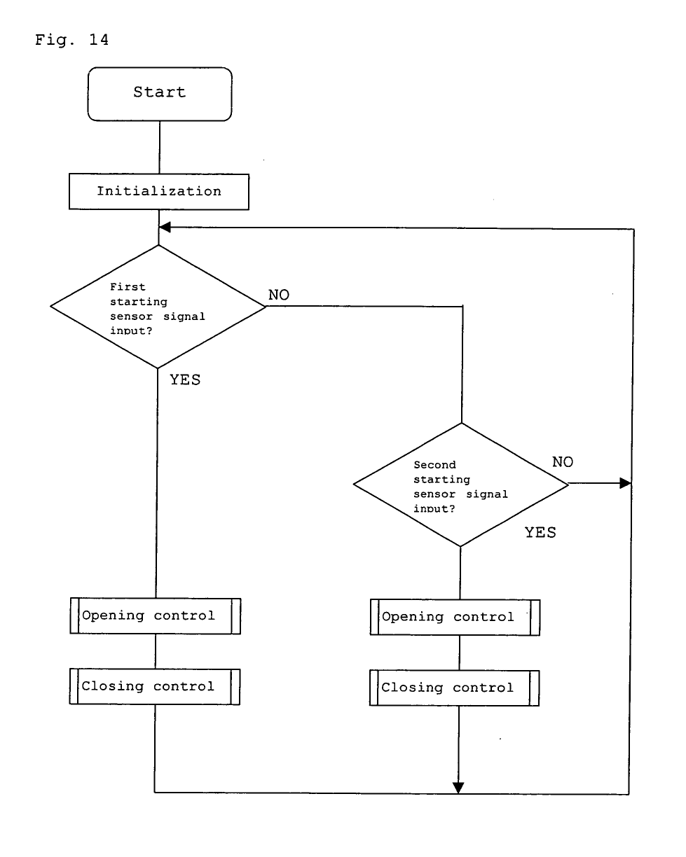

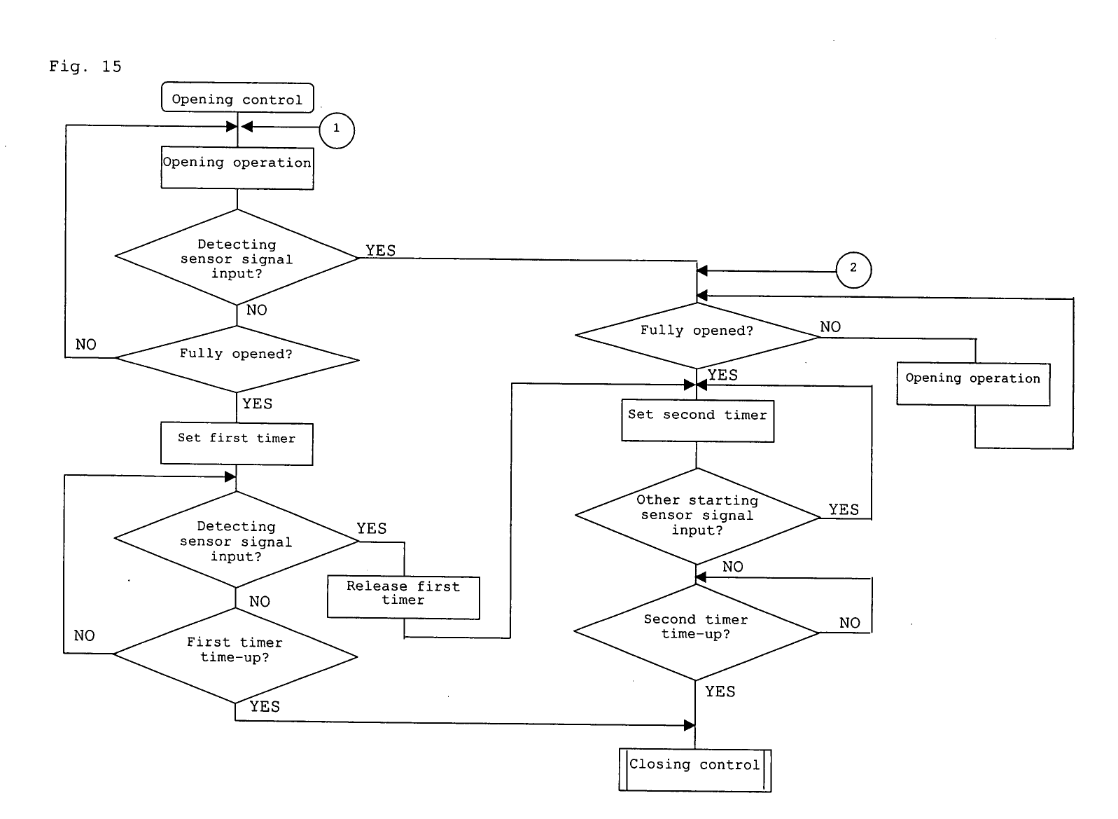

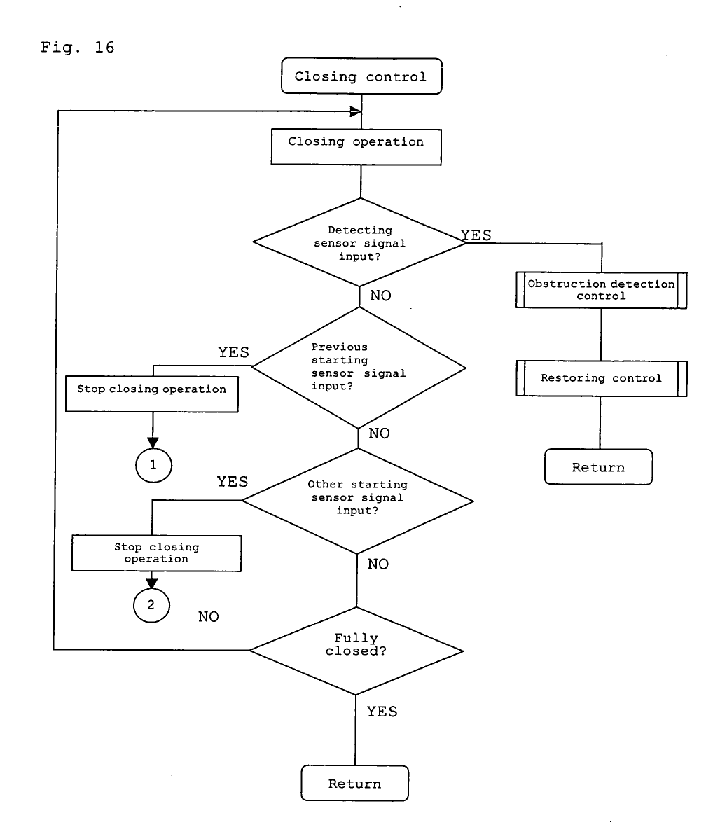

Subsequently, a third embodiment will be described with reference to FIG. 11 to FIG. 16. The sheet shutter device of this embodiment has the same structure as the first embodiment. The same reference numerals as the first embodiment are applied, and description of the structure is omitted.

The sheet shutter device of this embodiment is designed so that it is maintained fully closed at all times, and it is automatically opened at a predetermined high speed when there is a passing object and then automatically closed at a predetermined high speed, whereby the air conditioning atmosphere in the room can be maintained. Therefore, an electric-motor driven type opening/closing device 19 having an electric motor is interlockingly joined to the winding drum 3, and a controller 20 for controlling the rotational operation of the opening/closing device 19 is provided. The opening/closing device 19 of this embodiment is installed in the cylinder of the winding drum 3. Furthermore, first and second starting sensors 21, 22 are provided at the front and rear sides of the upper portion of the opening portion (entrance/exit portion), and also first and second detecting sensors 23, 24 are provided in the vicinity of the lower end portion of the shutter curtain 1 in the front-and-rear directions. These sensors 21, 22, 23, 24 are connected to the controller 20. Each of the first and second starting sensors 21, 22 is structured by using an infrared switch, and detects a passing object (person, vehicle or the like) in the vicinity of the opening portion to output a detection signal to the controller 20. Each of the first and second detecting sensors 23, 24 is structured by a photoelectric switch having a light emitter and a photodetector, and it detects a passing object or obstruction in the vicinity of the shutter curtain 1 to output a detection signal to the controller 20.

On the basis of input of a signal from any one of the first and second starting sensors 21, 22, the controller 20 outputs an opening operation command to the opening/closing device 19 so that the opening operation is carried out on the shutter curtain 1. After the shutter curtain 1 is opened, on the basis of the detection states of the first and second starting sensors 21, 22 and the first and second detecting sensors 23, 24, a closing operation command is output to the opening/closing device 19 after a proper time elapses so that the shutter curtain 1 is closed at a predetermined closing speed.

Next, an example of the procedure of the opening/closing control of the opening/closing device 19 by the controller 20 will be described. The sheet shutter device of this embodiment is designed to be in a fully-closed posture at all times. Therefore, when the system is started and initialized, the shutter curtain 1 is set to the fully-closed posture and under this state, the controller 20 determines whether there is an input of the detection signal from any one of the first and second starting sensors 21, 22, that is, whether a passing object such as a person, a vehicle or the like is close to the sheet shutter device. If there is an input of the detection signal from any one of the first and second starting sensors 21, 22, the opening control is carried out, and subsequently the closing control is carried out.

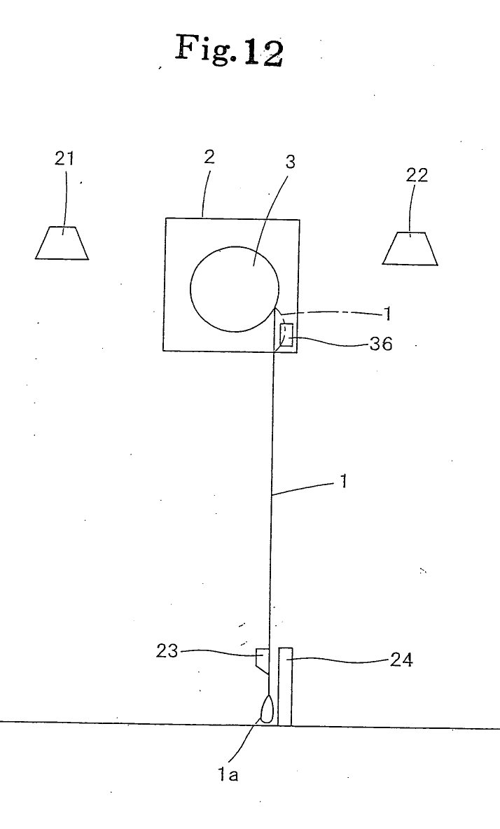

When a passing object (person, vehicle or the like) passes from the front side of the shutter curtain 1 at the left side of FIG. 12 (the right side of FIG. 11), the signal from the first starting sensor 21 located at the front side is input to the controller 20. Under this state, the controller 20 determines that there is a passing object moving from the front side of the sheet shutter device to the rear side thereof, and sets to start the opening control. Under the opening control, the controller 20 outputs an opening operation command to the opening/closing device 19, and carries out the opening operation on the shutter curtain 1. In the process of the opening operation, the controller 20 determines whether there is an input of the detection signal from any one of the first and second detecting sensors 23, 24. If it is determined that there is no input signal from any one of the first and second detecting sensors 23, 24 and the sheet shutter device is set to the fully-opened posture under the state that no passing object passes over the shutter curtain 1, the controller 20 sets a first timer in which the standby time under the fully-opened posture is long (for example, 60 seconds). When there is no signal input from any one of the first and second detecting sensors 23, 24 while the first timer time elapses (until time-up), the control is shifted to the closing control in connection with the time-up of the first timer.

On the other hand, when it is determined that the detection signal from any one of the first and second detecting sensors 23, 24 is input to the controller 20 and also the shutter curtain 1 is set to the fully-opened posture after a passing object passes over the shutter curtain 1, the controller 20 sets a second timer in which the standby time under the fully-opened posture is short (for example, 2 seconds), and determines whether there is a signal input from the second starting sensor 22 disposed behind the shutter curtain 1 while the timer time elapses. When it is determined that there is a signal input from the second starting sensor 22 (other starting sensor) disposed behind the shutter curtain 1 during the second timer time and a passing object is separated from the vicinity of the shutter curtain 1 to the rear side, the second timer having the shorter timer time is set at the same time as the signal input from the second starting sensor 22, and the control is shifted to the closing control in connection with the time-up of the second timer. If there is no signal input from the other second starting sensor 22, the control is shifted to the closing control in connection with the time-up of the second timer.

In the process of the opening operation, when there is no signal input from any one of the first and second detecting sensors 23, 24 after the signal input from the first starting sensor 21, the first timer is set and there is a signal input from any one of the first and second detecting sensors 23, 24 during the first timer time, it is determined that a passing object passes over the sheet shutter device, and the controller 20 sets off (releases) the first timer and also sets the second timer having the shorter timer time. If there is a signal input from the other second starting sensor 22 during the second timer time, the second timer is reset in connection with the signal input, and the control is shifted to the closing control in connection with the time-up of the second timer. Furthermore, when there is no signal input from the second starting sensor 22 during the second timer time, the control is shifted to the closing control in connection with the time-up of the second timer.

When the control is shifted to the closing control, the controller 20 outputs a closing operation command, and also determines whether there is a signal input from any one of the first and second detecting sensors 23, 24. If there is no input signal from any one of the first and second detecting sensors 23, 24 and thus there is no obstruction in the closing route of the shutter curtain 1, the controller 20 outputs a closing operation command until the shutter curtain 1 is set to the fully-closed posture on the basis of the fact that there is no signal input from the first and the second starting sensors 21, 22, and restores the state to an initialization state under which input of the detection signals from the first and second starting sensors 21, 22 is standby.

When there is the same signal input from the first starting sensor 21 as the previous control in the process of the closing operation, the controller 20 outputs an operation stop command to the opening/closing device 19, and also shifts the control to the opening control. The shutter curtain 1 is subjected to the opening operation in connection with the shift to the opening control.

When there is a signal input from the other second starting sensor 22 in the process of the closing operation, the controller 20 determines that a vehicle which has passed is still in the vicinity of the sheet shutter device, and outputs an operation stop command to the opening/closing device 19. In addition, the controller 20 carries out the opening control after the input from the first and second detecting sensors 23, 24 so that the shutter curtain 1 is opened.

On the other hand, when there is a signal input from any one of the first and second detecting sensors 23, 24 in the process of the closing operation of the shutter curtain 1, the controller 20 determines that some obstruction such as baggage or the like exists in the closing route of the shutter curtain 1 and carries out obstruction detection control. The obstruction detection control outputs an operation stop command to the opening/closing device 19 to stop the closing operation of the shutter curtain 1 during a predetermined timer time (for example, 1 second), and then outputs an opening operation command to open the shutter curtain 1 until the shutter curtain 1 is set to a predetermined fully-opened posture.

After obstruction detection control is carried out as described above, the shutter curtain 1 is set to the fully-closed posture on the basis of a restoring operation such as a manual operation or the like, thereby restoring the shutter curtain 1 to the initialization state. According to this embodiment, after a predetermined opening operation command is output, the opening posture is maintained during a predetermined timer time, and then a closing operation command is output to close the shutter curtain 1. On the basis of the setting of the shutter curtain 1 to the fully-closed posture, the initialization state, that is, the state that the detection signals from the first and second starting sensors 21, 22 are standby is restored.

As described above, according to the control structure of the controller 20, in such a case where a vehicle temporarily stops in the vicinity of the shutter curtain 1, that is, when some detection is carried out by any one of the first and second starting sensors 21, 22, but no detection is carried out by the first and second detection sensors 23, 24, the standby time until the closing operation is started from the fully-opened posture is set to a long time, and thus an accident, etc., can be prevented. In such a case that a vehicle or the like passes over the opening portion and drives away therefrom, the closing operation is started after the shorter timer time elapses, so that the closing operation is quickly carried out. Therefore, the operability can be made excellent with maintaining sufficient safety.

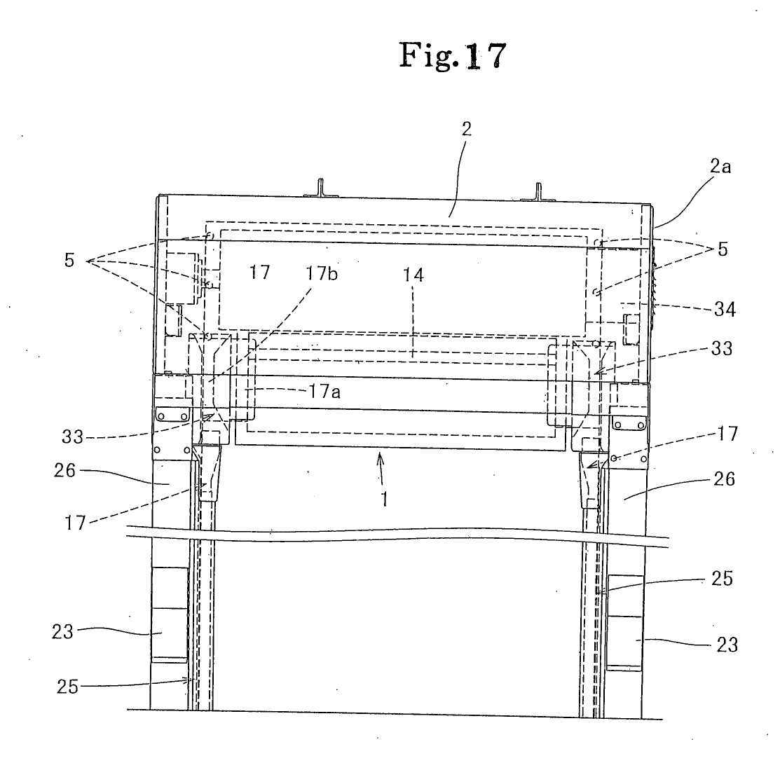

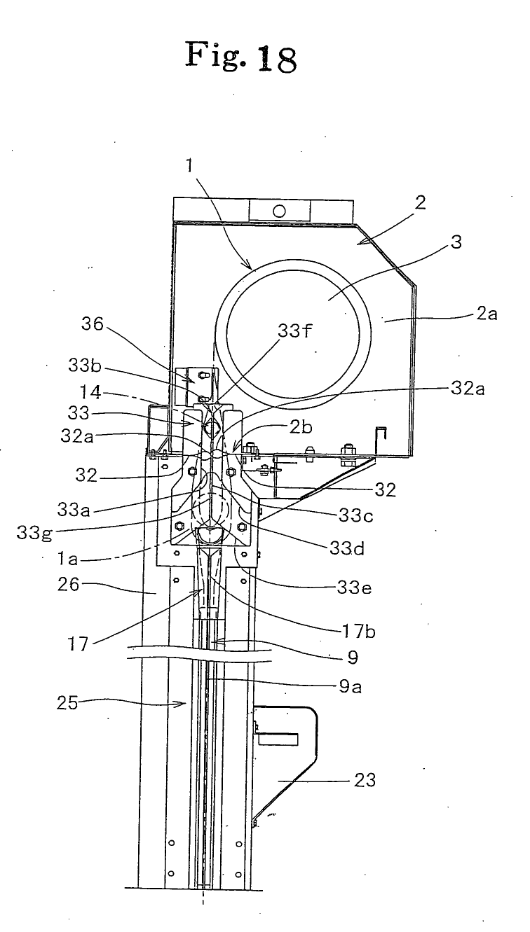

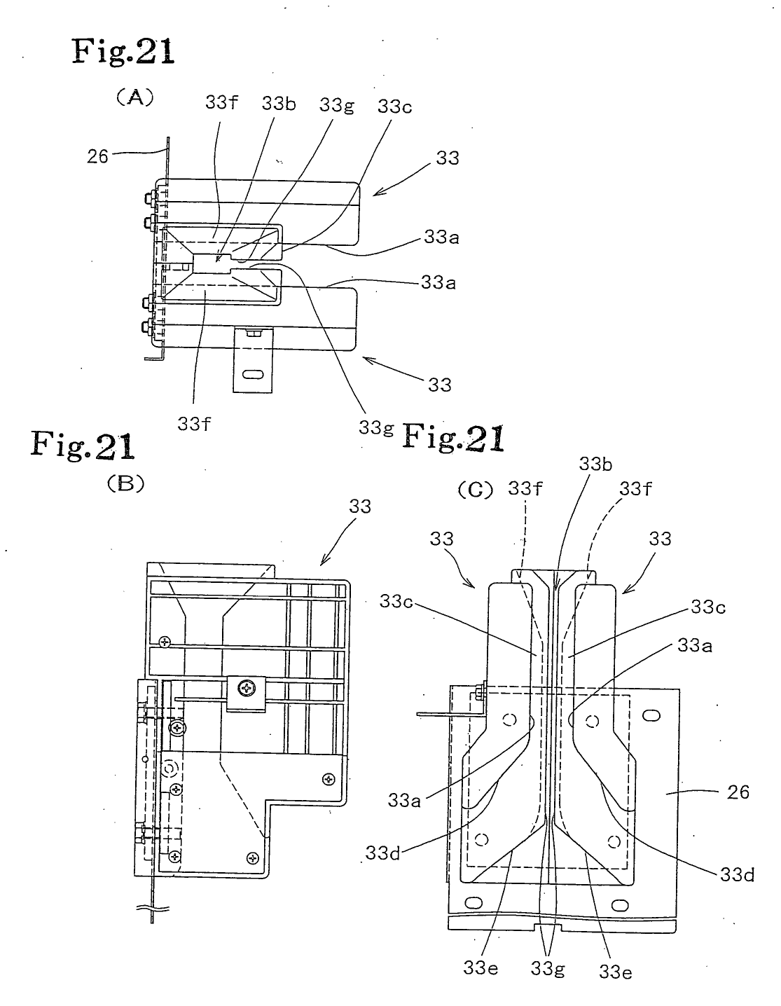

Next, a fourth embodiment will be described with reference to FIG. 17 to FIG. 21.

A guide rail 25 of the fourth embodiment is formed integrally in the vertical direction on one side piece portion 26a of a fixing bracket 26 corresponding to the fixing bracket 7 of the first embodiment, and the one side piece portion 26a is provided with a recess portion 26b which is outwardly stepped and first and second buffer members 27, 28 are provided to the inside (opening portion side) and the outside of the recess portion 26b in the right-and-left direction. These buffer members 27, 28 comprise elongated members which are long in the vertical direction and formed of elastically deformable material like the buffer member of the first embodiment. A recess portion 28a which is concaved outward from the outer surface of the recess portion 26b of the fixing bracket 26 is formed in the second buffer member 28, and the coming-off preventing load of the fitting piece 5 based on the elastic force of the second buffer member 28 can easily be adjusted by the size of the recess portion 28a.

The first buffer member 27 is engagedly fitted in the recess portion 26a of the fixing bracket at an outer half portion thereof. The outer portion of the support rail 29 which is long in the vertical direction and formed of rigid material such as metal material to have a U-shaped section is engagedly fitted in a recess groove portion 27a formed in the first buffer member 27, and integrated by means such as adhesion or the like. Accordingly, the inner portion of the support rail 29 can be displaced (forward or backward swung) within a predetermined range in the front-and-rear directions on the basis of the elastic deformation of the first buffer 27.

Furthermore, as in the case of the first embodiment, a rail body 9, an auxiliary rail 10 and long bolts 30 are disposed in the support rail 29, and the arrangement structure of these elements is as described above, however, a coil spring 30b is wound around the shaft portion 30a of each long bolt 30 projecting into the rectangular tube of the fixing bracket 26, and the urging force of the coil spring 30b is applied as the coming-off preventing load of the fitting piece 5 together with the elastic force of the second buffer member 28. Reference numeral 31 denotes a receiving plate member, and the receiving plate member 31 of this embodiment has folded pieces 31a at both side edges in the longitudinal direction to enhance the strength of the receiving plate to deformation.

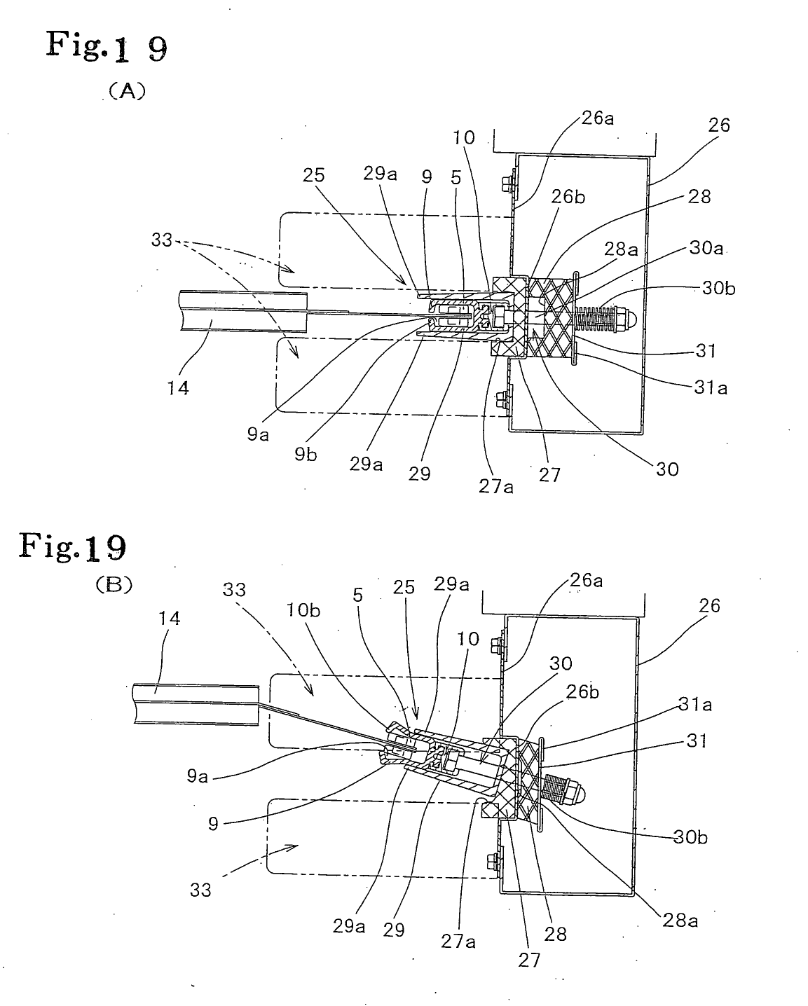

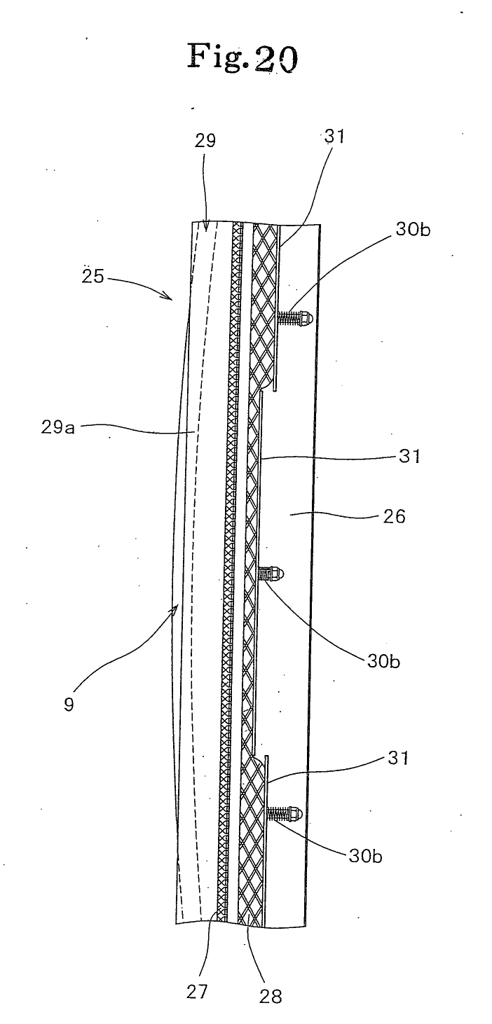

Even in this case, the rail grove 9a of the rail body 9 is subjected to deformation regulation by the opposing piece portions 29a of the support rail 29. When the fitting piece 5 pulls the rail body 9 in the front-and-rear directions and in the right-and-left direction on the basis of the load imposed on the shutter curtain 1, the rail body 10 is relatively slid in the support rail 29 against the urging force of the coil spring 30b and the elastic force of the second buffer material 28 via the receiving plate member 31 (see FIG. 20), and also the support rail 29 receives the elastic deformation of the first buffer member 27 and is swung and displaced in the front-and-rear directions (see FIG. 19(B)). Here, the recess portion 28a of the second buffer member 28 has an effect of enhancing the followability of the long bolt 30 which is forward and backward swung together with the support rail 29. As in the case of the structure of the above-described embodiment, when the fitting piece 5 slides the rail body 9 relatively to the support rail 29 and the rail body 9 comes off from the support rail 29, the deformation regulation of the rail groove 9a of the rail body 9 by the opposing piece portions 29a of the support rail 29 is lost, and thus the rail groove 9a is deformed, so that the fitting piece 5 comes off.

As described above, in the guide rail 25 of this embodiment, it is permitted that the support rail 29 receives the elastic force of the first buffer member 27 and is swung in the front-and-rear directions, so that it is forward/backward swung by action of a load on the shutter curtain 1 in the front-and-rear directions. Therefore, when the rail body 9 comes off by the load in the front-and-rear directions, the load acting locally on any one coming-off preventing piece portion 9b can be reduced, and further the support rail 29 is displaced in the load direction, so that the coming-off load can be easily adjusted.

Furthermore, the shutter case 2 of this embodiment is equipped with a lintel sheet 32 which closes the case entrance/exit portion 2b and exhibits an effect as a smokescreen.

That is, the lintel sheet 32 is formed of material having the same flexibility as the sheet shutter 1, and comprises a pair of front and rear sheets. Furthermore, each lintel sheet 32 is folded at the tip end portion thereof to form a bag portion 32a, and the base end portions thereof are integrally provided to the case entrance/exit portion 2b, so that the sheet shutter curtain 1 passing via the case entrance/exit portion 2b is sandwiched by the base end portions from the front and rear sides. Furthermore, in the lintel sheet 32 thus constructed, the bag portion 32a is deformed in the up-and-down direction and in the front-and-rear directions, thereby allowing the posture holding bar 14 to move upwardly and downwardly in connection with the opening/closing operation of the shutter curtain 1, and also the bag portion 32a is designed to follow the bending of the shutter curtain 1 in the front-and-rear directions. Accordingly, attention is paid so that sealing performance is not lost.

Furthermore, a pair of fourth guide bodies 33 corresponding to the integrated assembly of the first and second guide bodies 15, 16 of the first embodiment are provided between the upper end portion of each of the right and left guide rails 25 and the winding drum 3. That is, the fourth guide bodies 33 are provided between the winding drum 3 and the upper end portion of the rail groove 9a of the pair of right and left guide rails 25, and the posture holding bar 14 provided to the lowermost end portion of the shutter curtain 1 is guided (positionally oriented) to the opposing position to the rail groove 9a in the front-and-rear directions. The fourth guide bodies 33 may be formed of resin material having no flexibility (resin material having flexibility may be used), and fixed to the fixing bracket 26 as in the case of the first embodiment. Guide faces 33a are formed on the respective fourth guide bodies 33 so that they are located inside in the right-and-left direction so as to sandwich the end portion of the posture holding bar 14 from the front and rear sides in proximity with each other. These guide faces 33a are designed to be longer than the arrangement pitch (interval) of the fitting pieces 5 of the shutter curtain 1, whereby the degree of freedom of the positional relationship between the posture holding bar 14 and the fitting piece 5 located at the lowermost end can be increased. A fitting piece guiding portion 33b is formed at the outside of the guide faces 33a in the right-and-left direction while the confronting interval thereof is narrowed so that the fitting piece 5 is guided so as to oppose the upper site of the support rail 29 constituting the guide rail 25 while being prevented from coming off. Step faces 33c opposing the right and left end faces of the posture holding bar 14 are formed between the guide faces 33a and the fitting piece guide portion 33b. Accordingly, the positional regulation (positioning) of the posture holding bar 14 in the right-and-left direction is carried out.

Lower guide faces 33d and 33e serving inclined faces whose opposing interval is increased to the lower side are formed at the lower sides of the guide faces 33a and the fitting piece guide portion 33b of the fourth guide bodies 33 so as to be continuous with the guide faces 33a and the fitting piece guide portion 33b, respectively. Here, the maximum opposing interval between the lower side guide faces 33d is set under the same condition as the first embodiment. Furthermore, upper side guide faces 33f which are inclined to guide the fitting piece 5 so that the opposing interval therebetween is increased to the upper side are formed at the upper portion of the fitting piece guide portion 33b from the front and rear and right and left faces, whereby the fitting piece 5 is smoothly moved from the winding drum 3 to the fourth guide bodies 33.

Curtain guide faces 33g extending along the curtain face of the shutter curtain 1 are formed at the inside of the fitting piece guiding portion 33b in the right-and-left direction so as to be long in the right-and-left direction, thereby guiding the right and left edge portions of the shutter curtain 1. Accordingly, the guide-movement of the shutter curtain 1 can be carried out on a broad plane, and it is considered that the winding posture of the shutter curtain 1 around the winding drum 3 is prevented from being disturbed (winding deformation is prevented) during the opening operation of the shutter curtain 1. Furthermore, there can be smoothened distortion caused by an increase in thickness in the vicinity of the right and left end portion by the fitting portions 5 disposed at the right and left end portions as compared with the intermediate portion in the closing operation of the shutter curtain 1, and the resistance between the shutter curtain 1 and the rail groove 9a can be reduced.

The third guide body 17 of the first embodiment is provided at the lower side of the fourth guide body 33, and the fitting piece 5 is reliably guided to the fitting piece guide portion 33b.

In the third and fourth guide bodies 17 and 33 of this embodiment, the fitting piece 5 at the lower end portion is fitted to the fitting piece guide portion 33b in conformity with the timing at which the posture holding bar 14 is guided to the guide face 33a, whereby the fitting piece 5 coming off from the guide rail 25 is automatically restored to be engagedly fitted in the guide rail 25.

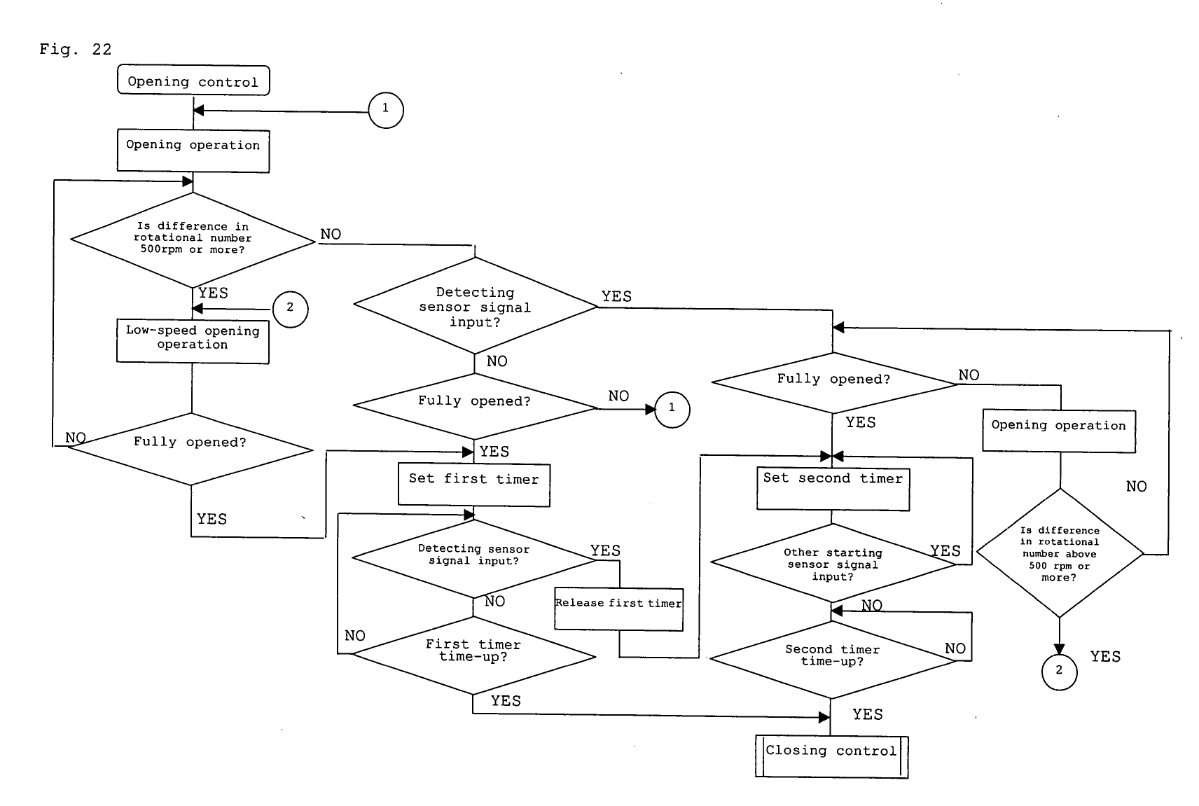

Next, a fifth embodiment will be described with reference to a flowchart of FIG. 22. The fifth embodiment is designed so that the opening/closing device 34 provided for the sheet shutter device having the basic structure of the fourth embodiment is provided with a rotation detecting sensor 35 for detecting the rotational number of the opening/closing device 34, and the operation control of the opening/closing device 34 is carried out on the basis of the control procedure of the controller (not shown) of the third embodiment.

When a detection value from the rotation detecting sensor 35 is reduced to be less than a predetermined rotational number in the opening operation of the shutter curtain 1, the controller of this embodiment determines that the fitting piece 5 of the shutter curtain 1 comes off from the rail groove 9a, and an automatic restoration and protection control of setting the opening speed of the opening/closing device 34 from a high speed to a low speed is carried out. Accordingly, when the fitting piece 5 of the shutter curtain 1 comes off from the rail groove 9a, the opening operation is carried out at a low speed, so that the automatic restoration of the fitting piece 5 to the rail groove 9a can be reliably performed by the third and fourth guide bodies 17, 33 and the posture holding bar 14.

In this case, when a detection value input from the rotation detecting sensor 35 during the opening operation of the shutter curtain 1 is smaller than the rotational number based on a predetermined opening speed by a predetermined rotational number or more (reduced, in this embodiment to 500 revolutions per minute (rpm)), the controller determines that the fitting piece 5 comes off from the rail groove 9a, and thus carries out the automatic restoring and protecting control. In the automatic restoring and protecting control, the controller outputs a low-speed opening operation command to an opening/closing device 34 so that the opening speed of the shutter curtain 1 is lower than a predetermined high speed. Accordingly, when the fitting piece 5 comes off from the rail groove 9a and the shutter curtain 1 which is free from the guide rail 25 is taken up, rip and tear of the shutter curtain 1 can be suppressed, so that the automatic restoring operation of the fitting piece 5 by the respective guide bodies 17 and 33 and the posture holding bar 14 can be reliably performed and thus the shutter curtain 1 can be protected.

Next, the control procedure of the automatic restoring and protecting control will be described with reference to the flowchart of FIG. 22. In this case, there will also be described such a state that a passing object is about to pass from the front side of the shutter curtain 1 and thus a detection signal is input from the first starting sensor 23 to carry out the opening control. In this case, the controller determines whether the detection value of the rotational number of the opening/closing device 34 by the rotational detecting sensor 35 is lower than the rotational number in the normal opening operation by 500 revolutions per minute (rpm) or more. If it is determined that it is not lower by 500 rpm or more, the controller determines that the normal opening operation is carried out, and an opening operation instruction based on a predetermined high opening speed is output. The control at this time is the same as the third embodiment, and the shutter curtain 1 is closed after a lapse of the first or second timer time in accordance with an input situation of the detection signal from the first and second detecting sensors 23, 24 and the detection signals from the first and second starting sensors 21, 22. Detailed description of the control is made for the third embodiment, and thus it is omitted from the following description.

On the other hand, when the detection value of the rotational number is lower by 500 revolutions per minute (rpm) or more, the controller carries out the automatic restoring and protecting control. In the automatic restoring and protecting control, a low-speed opening operation command is output to the opening/closing device 34 so that the opening speed of the shutter curtain 1 is set to a predetermined low speed (a speed at which rip and tear of the shutter curtain 1 can be prevented), thereby preventing the shutter curtain 1 from being damaged in advance. With respect to the opening operation based on detection of an obstruction, the controller may also carry out the automatic restoring and protecting control on the basis of the detection value from the rotational detecting sensor 35 when the rotational number is lower by 500 revolutions per minute (rpm) or more. In the automatic restoring and protecting control of the controller, the low-speed opening operation command may be output after an operation stop command is output in advance. In this case, the shutter curtain 1 is temporarily stopped and then the opening operation is carried out at a low speed. Therefore, the shutter curtain 1 can be further protected.

The detection of the coming-off of the shutter curtain 1 from the guide rail 4 (disengagement of the fitting piece 5 from the rail groove 9a) may be carried out on the basis of a variation amount of a current supply value to the opening/closing device 34. In this case, too, the disengagement can be detected on the basis of comparison with a predetermined current value with a simple structure. Accordingly, the return of the fitting piece 5 of the shutter curtain 1 to the rail groove 9a can be reliably performed with a simple and low-cost structure, and the sheet shutter device can be protected.

In the control procedure, the variation of the rotational number (disengagement state) is detected in the whole process for opening the shutter curtain. However, as a condition of disengagement of the fitting piece, because the following cases are assumed, that is, “after there is a signal input from the first and second detecting sensors 23, 24 in the process of the opening operation” or “after there is a signal input from the first and second detecting sensors 23, 24 during the closing operation”, it may be structured that the rotational number of the opening/closing device 34 is detected in the above control process.

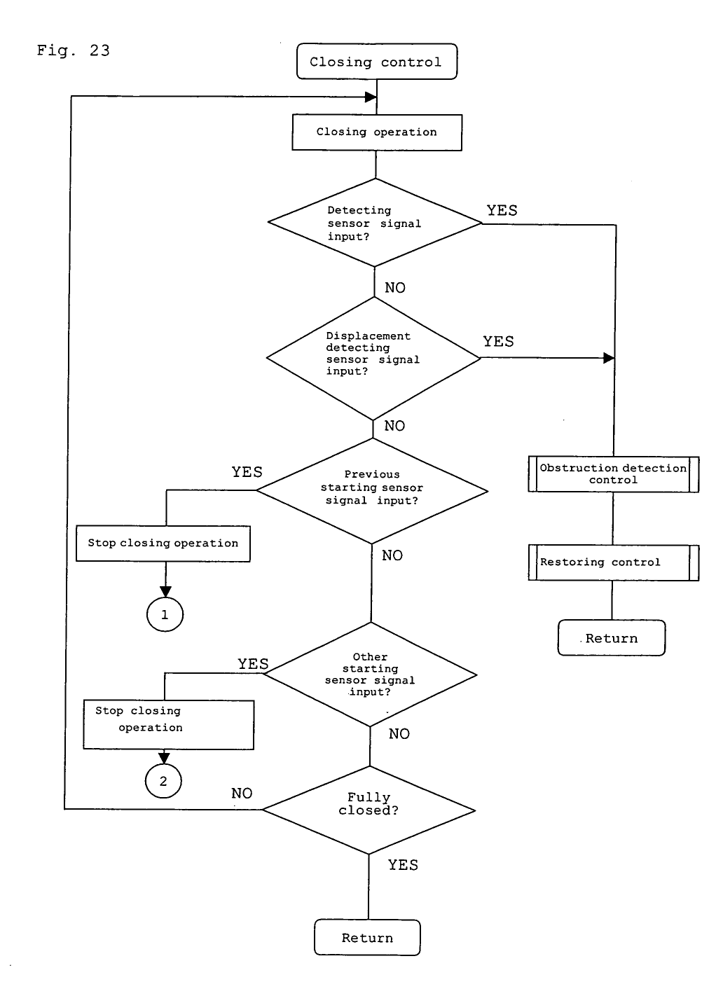

FIG. 23 is a flowchart showing a sixth embodiment. According to the sixth embodiment, in the sheet shutter device having the control structure described with respect to the third embodiment, a displacement detecting sensor 36 for detecting a shutter curtain 1 which is excessively wound off from the winding drum 3 and thus slackens (displaces) is provided at the right and left side plates 2a of the shutter case 2 when the shutter curtain 1 abuts against an obstruction, and the flowchart shows the control procedure of opening the shutter curtain 1 on the basis of obstruction detection indicating that the displacement detecting sensor 36 detects displacement of the shutter curtain 1.

In this embodiment, when there is an obstruction which cannot be detected by the first and second detecting sensors 23, 24, for example, the shutter curtain 1 abuts against a tip portion of a heavy vehicle and slackens, the displacement detecting sensor 36 detects that the shutter curtain 1 displaces so as to expand in the shutter case 2. The displacement detecting sensor 36 is structured by a photoelectric switch having a light emitter and a photodetector, and is disposed at each of the right and left side plates 2a in the shutter case 2 so that the optical axis of the light emitter is parallel to the shutter curtain 1 and is spaced from the outer peripheral surface of the shutter curtain 1 which is separated from the winding drum 3 and maintained hung while maintaining a predetermined interval from the shutter curtain 1. In this embodiment, the displacement detecting sensors 36 are disposed at the lower sides of the right and left side plates 2a in the vertical direction and just above the fourth guide bodies 33 (guide rails 4) so that the shutter curtain 1 displacing in the shutter case 2 can be detected over the whole area in the right-and-left width direction. The detection can be performed even when the shutter curtain 1 abuts against the obstruction at any place. In addition, the displacement detecting sensor 36 is structured by a photoelectric sensor, whereby the detection action can be carried out just when the optical axis is intercepted, and obstruction detection can be performed more quickly and reliably.

The controller (not shown) outputs the closing operation command in the closing control after the shutter device is opened on the basis of the first starting sensor 21, determines that there is no obstruction if there is no input detection signal from the first and second detecting sensors 23, 24 and the displacement detecting sensor 36 in the process of the closing operation of the shutter curtain 1, and carries out the closing operation on the basis of the no input detection signals from the first and second starting sensors 21, 22 until the shutter curtain 1 is set to the fully-closed posture. On the other hand, if there is a detection signal input from the first and second detecting sensors 23, 24 or from the displacement detecting sensor 36, the controller determines this as obstruction detection and carries out obstruction detection control. In obstruction detection control, the controller outputs the operation stop command to the opening/closing device during a predetermined time, and then outputs the opening operation command until the shutter curtain 1 is set to the preset opening posture.

If there is a detection signal input from the first starting sensor 21 in the process of the closing operation after the opening operation is carried out on the basis of the first starting sensor 21, the control is shifted to the opening control, and if there is a detection signal input from the other first starting sensor 22, the control is shifted to the opening control after the detection based on the first and second detecting sensors 23, 24.

Accordingly, in the sheet shutter device, even when obstruction detection cannot be performed by the first and second detecting sensors 23, 24, if obstruction detection based on the displacement detecting sensor 36 is carried out, obstruction detection control is executed, so that obstruction detection can be more reliably performed.

### INDUSTRIAL APPLICABILITY

As described above, the sheet shutter device of the present invention is effectively used as a shutter device provided to the opening portion of an architectural structure or the like, and particularly it is suitably used in a case where air conditioning atmosphere in a room can be maintained.

1. A sheet shutter device in which fitting pieces are provided at both side portions of a sheet-shaped shutter curtain so as to be spaced from one another at a predetermined pitch in a vertical direction and made to run while engagedly fitted in rail grooves of guide rails provided at both side portions of an opening portion, thereby opening/closing the opening portion, the rail grooves designed so that the fitting pieces come off from the rail grooves under an excessive load imposed on the shutter curtain, wherein an posture holding bar is provided to at least the lower end portion of the shutter curtain so as to be spaced from the fitting pieces in the curtain width direction, and at the upper side of each of the rail grooves are provided a first guide body for guiding the posture holding bar to an opposing position to each of the rail grooves and a second guide body for guiding the fitting piece at the lower end portion of the shutter curtain toward each of the rail grooves in conformity with a timing at which the posture holding bar is guided to the opposing position to the rail groove by the first guide body are provided at the upper side of each of the rail grooves.

2. The sheet shutter device according to claim 1, wherein the second guide body is formed to be longer in the vertical direction than the pitch of the fitting pieces.

3. The sheet shutter device according to claim 1, wherein a third guide body for guiding the fitting pieces toward each of the rail grooves is provided between the upper end portion of the rail groove and the first guide body.

4. The sheet shutter device according to claim 3, wherein the third guide body is provided with a freely deformable piece which can be deformed in front-and-rear directions corresponding to a direction perpendicular to the curtain face.

5. The sheet shutter device according to claim 1, wherein the first guide body has a pair of guide faces for guiding the posture holding bar to the opposing position to the rail groove, and guideways which are inclined-shaped and guide the posture holding bar to the guide face are formed on the guide face at the upper and lower sides.

6. The sheet shutter device according to claim 3, wherein the freely deformable piece of the third guide body is formed so as to be located in an opposing gap between the guideways at the lower side of the first guide body.

7. The sheet shutter device according to claim 1, wherein the first and second guide bodies are integrally formed with each other.

8. The sheet shutter device according to claim 5, wherein a step face for regulating the position in the right-and-left direction of the posture holding bar is formed between the guide face of the first guide body and a fitting piece guide portion which is formed in the second guide body and guides the fitting pieces toward the rail groove.

9. The sheet shutter device according to claim 8, wherein a curtain guide face for guiding both right and left side edge portions of the shutter curtain is formed in the fitting piece guide portion of the second guide body.

10. The sheet shutter device according to claim 1, wherein the guide rail comprises a support rail fixed to each of both sides of the opening portion, a rail body which is engaged with the fitting pieces and supported so as to be freely displaced to the inside of the opening portion with respect to the support rail, and urging means for urging outwardly the rail body displaced to the inside of the opening portion in connection with a load imposed on the shutter curtain, the urging means comprises an elongated elastic member disposed along the outer surface of the support rail, an elongated receiving plate member applied to the outer surface of the elastic member and a joint member provided between the rail body and the receiving plate member so as not to come off, and an elastic deforming force of the elastic member acts on the rail body via the receiving plate member.

11. The sheet shutter device according to claim 2, wherein a third guide body for guiding the fitting pieces toward each of the rail grooves is provided between the upper end portion of the rail groove and the first guide body.

12. The sheet shutter device according to claim 11, wherein the third guide body is provided with a freely deformable piece which can be deformed in front-and-rear directions corresponding to a direction perpendicular to the curtain face.

13. The sheet shutter device according to claim 2, wherein the first guide body has a pair of guide faces for guiding the posture holding bar to the opposing position to the rail groove, and guideways which are inclined-shaped and guide the posture holding bar to the guide face are formed on the guide face at the upper and lower sides.

14. The sheet shutter device according to claim 4, wherein the first guide body has a pair of guide faces for guiding the posture holding bar to the opposing position to the rail groove, and guideways which are inclined-shaped and guide the posture holding bar to the guide face are formed on the guide face at the upper and lower sides.

15. The sheet shutter device according to claim 4, wherein the freely deformable piece of the third guide body is formed so as to be located in an opposing gap between the guideways at the lower side of the first guide body.

16. The sheet shutter device according to claim 4, wherein the first and second guide bodies are integrally formed with each other.

17. The sheet shutter device according to claim 15, wherein the first and second guide bodies are integrally formed with each other.

18. The sheet shutter device according to claim 4, wherein the guide rail comprises a support rail fixed to each of both sides of the opening portion, a rail body which is engaged with the fitting pieces and supported so as to be freely displaced to the inside of the opening portion with respect to the support rail, and urging means for urging outwardly the rail body displaced to the inside of the opening portion in connection with a load imposed on the shutter curtain, the urging means comprises an elongated elastic member disposed along the outer surface of the support rail, an elongated receiving plate member applied to the outer surface of the elastic member and a joint member provided between the rail body and the receiving plate member so as not to come off, and an elastic deforming force of the elastic member acts on the rail body via the receiving plate member.

19. The sheet shutter device according to claim 9, wherein the guide rail comprises a support rail fixed to each of both sides of the opening portion, a rail body which is engaged with the fitting pieces and supported so as to be freely displaced to the inside of the opening portion with respect to the support rail, and urging means for urging outwardly the rail body displaced to the inside of the opening portion in connection with a load imposed on the shutter curtain, the urging means comprises an elongated elastic member disposed along the outer surface of the support rail, an elongated receiving plate member applied to the outer surface of the elastic member and a joint member provided between the rail body and the receiving plate member so as not to come off, and an elastic deforming force of the elastic member acts on the rail body via the receiving plate member.

20. The sheet shutter device according to claim 16, wherein the guide rail comprises a support rail fixed to each of both sides of the opening portion, a rail body which is engaged with the fitting pieces and supported so as to be freely displaced to the inside of the opening portion with respect to the support rail, and urging means for urging outwardly the rail body displaced to the inside of the opening portion in connection with a load imposed on the shutter curtain, the urging means comprises an elongated elastic member disposed along the outer surface of the support rail, an elongated receiving plate member applied to the outer surface of the elastic member and a joint member provided between the rail body and the receiving plate member so as not to come off, and an elastic deforming force of the elastic member acts on the rail body via the receiving plate member.
